(19) United States
(12) Patent Application Publication
(10) Pub. No.: US 2016/0125843 A1
(43) Pub. Date: May 5, 2016

(54) DISPLAY DRIVER IC AND ELECTRONIC DEVICE INCLUDING THE SAME

(71) Applicants: Yang-hyo KIM, Suwon-si (KR); Jin-hong HWANG, Seoul (KR); Kyung-sang CHO, Incheon (KR)

(72) Inventors: Yang-hyo KIM, Suwon-si (KR); Jin-hong HWANG, Seoul (KR); Kyung-sang CHO, Incheon (KR)

(21) Appl. No.: 14/824,683

(22) Filed: Aug. 12, 2015

(30) Foreign Application Priority Data
Nov. 5, 2014 (KR) 10-2014-0152864

(51) Int. Cl. G09G 5/02; G09G 5/00

(52) U.S. Cl. CPC G09G 5/028; G09G 5/006; G09G 2320/0666; G09G 2330/023; G09G 2320/0276; G09G 2320/08

(57) ABSTRACT

Provided are a display driver integrated circuit (IC) and an electronic device including the same. The display driver IC includes a control unit for activating a gray mode signal based on an external signal input to the control unit; and a data processing unit for processing input data as gray data in a gray mode, in response to the gray mode signal.

### CROSS-REFERENCE TO RELATED APPLICATION

This application claims the benefit of Korean Patent Application No. 10-2014-0152864, filed on Nov. 5, 2014, in the Korean Intellectual Property Office, the disclosure of which is incorporated herein in its entirety by reference.

### BACKGROUND

The inventive concepts presented relate to a display driver integrated circuit (IC) that may reduce power consumption, and/or an electronic device that includes the same.

Various efforts for reducing power consumption of an electronic device have been made. Particularly, it may be an important issue to reduce power consumption which occurs when an electronic device displays an image.

### SUMMARY

The inventive concepts provide a display driver integrated circuit (IC) that may reduce power consumption, and/or an electronic device that includes the same.

According to an aspect of the inventive concepts, there is provided a display driver integrated circuit (IC) including a controller configured to activate a gray mode signal based on an external signal that is input to the controller; and a data processor configured to operate in a gray mode, in response to the gray mode signal, the gray mode including processing input data as gray data.

Some example embodiments may include wherein the external signal comprises a command indicating that the display driver IC is to operate in the gray mode.

Some example embodiments may include wherein the input data includes at least two types of color data, and the data processor is further configured to process the input signal as the external signal and transmits the processed input signal to the display driver IC when the input data does not include at least one piece of color data associated with the at least two types of color data.

Some example embodiments may include wherein the external signal comprises information regarding the power status of an electronic device that comprises the display driver IC.

Some example embodiments may include at least two data paths, each data path including at least one sub-path, and the data processor is further configured to, deactivate at least one sub-path included in at least one data path selected from the group including at least two data paths, and process the input data as a driving voltage to drive a display panel in a normal mode, the input data including at least two pieces of color data.

Some example embodiments may include at least one non-deactivated sub-path comprising circuitry configured to perform compression or decompression on the at least two pieces of color data, and the data processor is further configured to, deactivate at least one sub-path included in at least one data path selected from the group including at least two data paths, and process the input data as a driving voltage to drive a display panel in a normal mode, the input data including at least two pieces of color data.

Some example embodiments may include at least one non-deactivated sub-path comprises circuitry configured to perform compression or decompression on the at least two pieces of color data.

Some example embodiments may include at least one non-deactivated sub-path comprising a circuitry configured to perform image processing on the at least two pieces of color data.

Some example embodiments may include at least one non-deactivated sub-path comprising a source driver configured to generate a driving voltage in accordance to the at least two pieces of color data.

Some example embodiments may include at least one non-deactivated sub-path comprising a source driver configured to generate the driving voltage in accordance to the at least two pieces of color data, the source driver including at least one shift register configured to shift the at least two pieces of color data.

Some example embodiments may include at least one non-deactivated sub-path comprises a circuitry configured to perform gamma correction on the at least two pieces of color data.

Some example embodiments may include at least one non-deactivated sub-path comprises a source driver configured to generate a driving voltage, the source driver including an amplifier configured to amplify an analog voltage in accordance with the at least two pieces of color data.

Some example embodiments may include the data processor is further configured to process a driving voltage generated for one piece of color data selected from a group including at least two pieces of color data from the input data, as a driving voltage for all color data included in the input data, in response to the gray mode signal.

Some example embodiments may include wherein the data processing unit includes an encoder configured to compress the input data, a graphics memory configured to store the compressed input data, a decoder configured to decompress the stored compressed data, an image processor configured to perform image processing on the decompressed data, and a source driver configured to process the image-processed data as a driving voltage for driving a display panel.

Some example embodiments may include wherein the data processor further comprises a data distribution unit configured to distribute, to the encoder in response to the gray mode signal, one piece of color data selected from a group including at least two pieces of color data from the input data.

Some example embodiments may include wherein the data processor further comprises an output unit configured to output, to the source driver in response to the gray mode signal, one piece of color data selected from a group including at least two pieces of color data from the input data.

Some example embodiments may include wherein the source driver includes a gamma correction unit configured to generate the image-processed data as a gamma-corrected analog voltage, and an amplifying unit configured to amplify and output the gamma-corrected analog voltage as the driving voltage, wherein the gamma correction unit is configured to receive one piece of color data selected from a group including at least two pieces of color data from the input data, in the gray mode.

Some example embodiments may include wherein the source driver includes a gamma correction unit configured to generate the image-processed data as a gamma-corrected analog voltage, and an amplifying unit configured to amplify and output the gamma-corrected analog voltage as the driving voltage, wherein the gamma correction unit is configured to gamma-correct the image-processed data based on gray gamma curve information, in the gray mode.

Some example embodiments may include a comma curve storage unit configured to store the gray gamma curve information.

Some example embodiments may include wherein the gray gamma curve information is transmitted from an external host.

Some example embodiments may include wherein the data processing unit is configured to generate the gray data as a driving voltage for all color data comprised in the input data, the generation based on processing of a driving voltage for a first color data selected from a group including at least two pieces of color data from the input data, if power of an electronic device that comprises the display driver IC is in a first state, and the data processing unit is configured to generate the gray data as a driving voltage for all color data comprised in the input data, the generation based on processing a driving voltage for second color data selected from the group including at least two pieces of color data comprised in the input data, if power of the electronic device that comprises the display driver IC is in a second state.

Some example embodiments may include wherein the data processor is configured to generate the gray data by processing a driving voltage for a first color data selected from the group including at least two pieces of color data from each input data, as a driving voltage for all color data comprised in the input data, if power of an electronic device that comprises the display driver IC is in a first state, and the data processor is configured to generate the gray data by processing a driving voltage for the first color data selected from the group including at least two pieces of color data comprised in one piece of the input data selected from the group including at least two pieces of the input data, as a driving voltage for all color data comprised in the at least two pieces of the input data, if power of the electronic device that comprises the display driver IC is in a second state.

Some example embodiments may include wherein the data processor is configured to operate in a normal mode in which a driving voltage is generated for at least two pieces of color data from the input data, if the gray mode signal is deactivated.

According to another aspect of the inventive concepts, there is provided a display system including a display driver integrated circuit (IC), the display driver IC including a controller configured to activate a gray mode signal based on an external signal, and a data processor configured to generate a driving voltage in response to the gray mode signal, and a display panel configured to display the input data as gray data, the display panel driven by the driving voltage from the display driver IC.

Some example embodiments may include wherein the data processor is configured to deactivate, in the gray mode, at least one sub-path comprised in at least one data path, selected from a group including data paths in which the driving voltage is generated for color data comprised in the input data in a normal mode.

According to another aspect of the inventive concepts, there is provided an electronic device including a display driver integrated circuit (IC); a display panel configured to be driven by using a driving voltage applied from the display driver IC, and the display driver IC includes a controller configured to activate a gray mode signal based on an external signal, and a data processor configured to generate the driving voltage in response to the gray mode signal, so that input data is displayed as gray data on the display panel.

According to another aspect of the inventive concepts, there is provided an electronic device including a display panel configured to display an image in accordance with driving voltages, a display driver integrated circuit (IC) configured to drive the display panel according to an input data, the display driver IC including, a controller configured to receive image data, the image data including a plurality of color data types, and the data processor configured to process the image data according to a received gray mode signal, the gray mode signal indicating whether the data processor operates in a gray mode or a normal color mode, the processing including generating the driving voltages for the display panel based on the image data and the gray mode signal.

Some example embodiments may include wherein if the data processor is operating under the gray mode, the data processor is configured to generate the driving voltages based on the image data without including color information.

Some example embodiments may include a power management integrated circuit (PMIC) configured to detect power information associated with the electronic device and generate the gray mode signal based on the detected power information.

Some example embodiments may include wherein the PMIC is further configured to generate the gray mode signal indicating that the data processor is to operate in the gray mode, if the detected power information is equal to or below a desired level.

Some example embodiments may include wherein the received gray mode signal is the received image data.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 illustrates a display driver integrated circuit (IC) according to an example embodiment;

FIGS. 2 through 4 respectively illustrate an electronic device according to an example embodiment;

FIG. 5 illustrates an electronic device according to another example embodiment;

FIGS. 6 and 7 respectively illustrate display panels according to an example embodiment;

FIG. 8 illustrates a display driver IC according to another example embodiment;

FIGS. 9A and 9B respectively illustrate example embodiments of a data path in a normal mode;

FIGS. 10 and 11 respectively illustrate display driver ICs according to other example embodiments;

FIGS. 12A and 12B illustrate example embodiments of first and second image processing paths shown in FIG. 11;

FIGS. 13 through 16 respectively illustrate display drivers IC according to other example embodiments;

FIG. 17 illustrates an example embodiment of a clock signal and a gray mode signal shown in FIG. 16;

FIGS. 18 through 22 respectively illustrate display drivers IC according to other example embodiments;

FIG. 23 illustrates an electronic device according to another example embodiment;

FIGS. 24 and 25 respectively illustrate display drivers IC according to other example embodiments;

FIGS. 26 through 28 respectively illustrate a method of controlling a display driver IC in a gray mode, according to an example embodiment;

FIG. 29 illustrates an electronic device according to another example embodiment;

FIG. 30 illustrates a display module according to an example embodiment;

FIG. 31 illustrates a display system according to an example embodiment; and

FIG. 32 illustrates an example of application of various electronic devices in which a display IC is equipped, according to an example embodiment.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

In example embodiments, a nonvolatile memory may be embodied to include a three dimensional (3D) memory array. The 3D memory array may be monolithically formed on a substrate (e.g., semiconductor substrate such as silicon, or semiconductor-on-insulator substrate). The 3D memory array may include two or more physical levels of memory cells having an active area disposed above the substrate and circuitry associated with the operation of those memory cells, whether such associated circuitry is above or within such substrate. The layers of each level of the array may be directly deposited on the layers of each underlying level of the array.

In example embodiments, the 3D memory array may include vertical NAND strings that are vertically oriented such that at least one memory cell is located over another memory cell. The at least one memory cell may comprise a charge trap layer.

The following patent documents, which are hereby incorporated by reference in their entirety, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

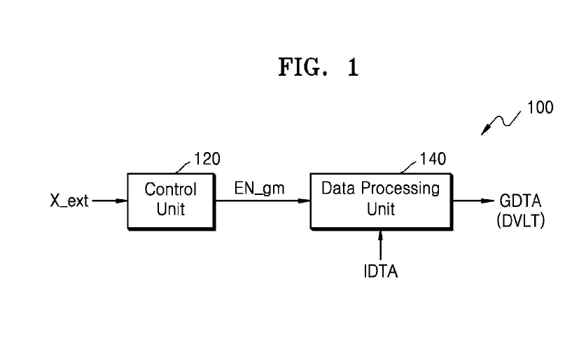

The following FIG. 1 illustrates a display driver integrated circuit (IC) 100 according to some example embodiments. Referring to FIG. 1, according to at least one example embodiment, the display driver IC 100 may include a control unit 120, i.e., a controller, and a data processing unit 140, i.e., a data processor.

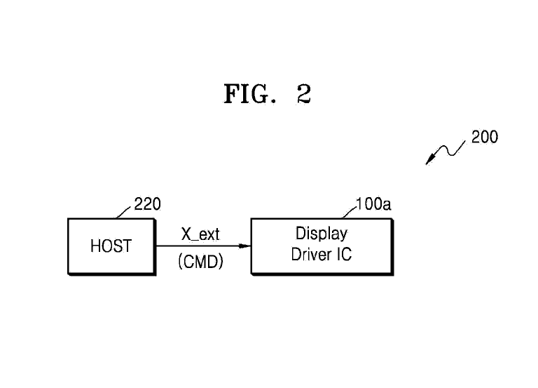

The control unit 120 may be configured to activate a gray mode (i.e., gray scale mode) signal EN_gm based on an input external signal X_ext. The control unit 120 may include a register set that may include information, a command, or the like, which is desired, useful for, and/or required for performing an operation. The external signal X_ext may be applied to a display driver IC as shown in FIGS. 2 through 4. For example, according to an example embodiment, with regard to an electronic device 200 shown in FIG. 2, a display driver IC 100a may receive the external signal X_ext, which may instruct the display driver IC 100a to operate in a gray mode, from a host 220. The gray mode refers to a mode in which the display driver IC 100 is operated, so that a gray image or gray data GDATA is displayed on a display panel of the electronic device 200 regardless of input data IDTA that is input to the display driver IC 100a. Gray image or Gray data refers to an image or data that does not include color information, for example, image or data of which a saturation value is 0. If a driving voltage DVLT, respectively applied to color data (and/or image data, hereinafter referred to collectively as “color data”), such as values for R, G, and B signals, are identical to each other, the gray data GDATA may be displayed.

The host 220 may be an application processor, a central processing unit (CPU), or other processing device. A single host 220 or a plurality of hosts 220 may be included. The host 220 and the display driver IC 100a may be implemented as separate chips, a module, a system-on-chip, a package (for example, a multi-chip package), etc.

The host 220 may transmit the external signal X_ext to the display driver IC 100a as a command CMD based on an instruction made by a user. The instruction made by a user may be transmitted to the host 220 via a user interface of the electronic device 200. For example, if the power level of the electronic device 200, for example, a remaining capacity of a battery has decreased to a value equal to or less than a reference value (i.e., a desired threshold value), a user may automatically or manually set the display driver IC 100a included in the electronic device 200 to operate in the gray mode. Additionally, the host 220 may directly check information about a remaining capacity of the battery included in the electronic device 200, and/or the power level of the electronic device 200, and output an external signal X_ext for instructing the display driver IC 100a to operate in the gray mode. The host 220 may transmit the external signal X_ext to the display driver IC 100a, by periodically checking a remaining capacity of the battery, checking the power level of the electronic device 200, or in response to an alarm generated when a remaining capacity of the battery is decreased to a value equal to or less than a reference value (or desired threshold value). Furthermore, the external signal X_ext may be transmitted by the host 220 to the display driver IC 100a when the electronic device 200 enters into a power saving mode, such as a device's sleep mode or a low power mode, either automatically based on a desired or certain criteria, or manually by a user of the electronic device 200.

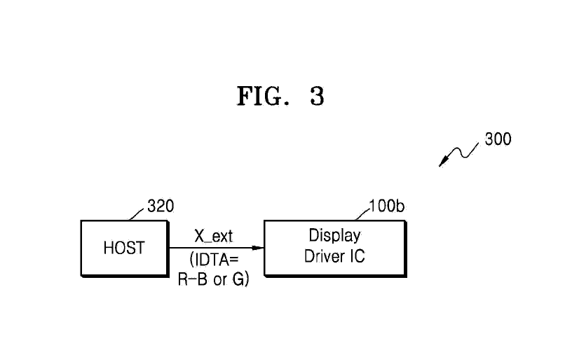

Additionally, according to some example embodiments, like an electronic device 300 shown in FIG. 3, input data IDTA may be processed as an external signal X_ext even when an external signal X_ext is not separately applied to a display driver IC 100b. The input data IDATA may include three or more types of color data, such as red (R), green (G), blue (B), cyan (C), magenta (M), yellow (Y), black (K), luminance, intensity, lightness etc., in a normal mode. A normal mode refers to a mode in which the display driver IC 100b performs a normal operation for driving a display panel by using a driving voltage that corresponds to each color data included in the input data IDTA. For example, each input data IDTA may include respectively 8 bits of color data R, G, and B, and thus, represent 16.7 million (M) colors, or may include respectively 6 bits of color data R, G, and B, and thus, represent 262 thousand (K) colors. The input data IDTA may be applied from a host 320, for example, in units of frames, in units of lines of a frame, or the like, wherein a frame is a unit by which a display panel, to be described later, displays an image.

In an idle mode, input data IDTA may include color data, such as R, G, and B data, having a value of 1 or 0 may be input to a display driver IC 100b. Accordingly, the input data IDTA may represent 8 colors in the idle mode, but is not limited thereto. The input data IDTA may be input to the display driver IC 100b in the idle mode by using a same method as in the normal mode, and the display driver IC 100b may process the color data, such as R, G, and B data, of the input data IDTA to respectively have a value of 1 or 0. A data path in the idle mode may be identical to a data path in the normal mode which is to be described later.

Additionally, if the host 320 instructs the display driver IC 100b to operate in a gray mode, the host 320 may transmit input data IDTA that may include a subset of the color and/or image data of the input data IDTA, for example a single color data selected from among the color data R, G, and B, to the display driver IC 100b. For example, when the input data IDTA includes respectively 8 bits of color data R, G, and B in a normal mode, if the host 320 instructs the display driving IC 100b to operate in a gray mode, the host 320 may transmit 8 bits of input data IDTA that includes only one of the color data R, G, and B to the display driver IC 100b. As another example, the host 320 may transmit 24 bits of input data IDTA that includes only the color data R, instead of the color data G and B, to the display driver IC 100b. If input data IDTA that includes only one piece of color data is received, the display driver IC 100b may process the input data IDTA as the external signal X-ext.

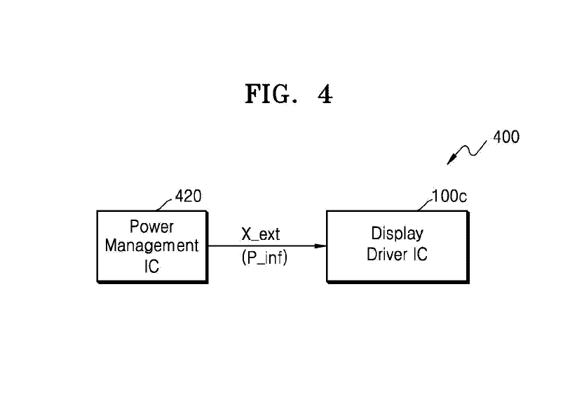

Additionally, according to some example embodiments, like an electronic device 400 shown in FIG. 4, an external signal X_ext may be transmitted to a display driver IC 100c as power information P_inf of the electronic device 400. The power information P_inf of the electronic device 400 may be information about a remaining capacity of a battery included in the electronic device 400, or other information related to the power usage/status of the electronic device 400. For example, a power management IC (PMIC) 420 included in the electronic device 400 may sense or check a remaining capacity of the battery and generate the remaining capacity as the power information P_inf.

Referring back to FIG. 1, the control unit 120 may activate the gray mode signal EN_gm based on the input external signal X_ext which is input as described with reference to FIGS. 2 through 4, so that the display driver IC 100 operates in a gray mode. The data processing unit 140 may receive the gray mode signal EN_gm and may operate in the gray mode. In the gray mode, the data processing unit 140 may process the input data IDTA as gray data GDTA. In other words, the data processing unit 140 processes the input data IDTA as the driving voltage DVLT that corresponds to the gray data GDTA. Hereinafter, this is described in detail.

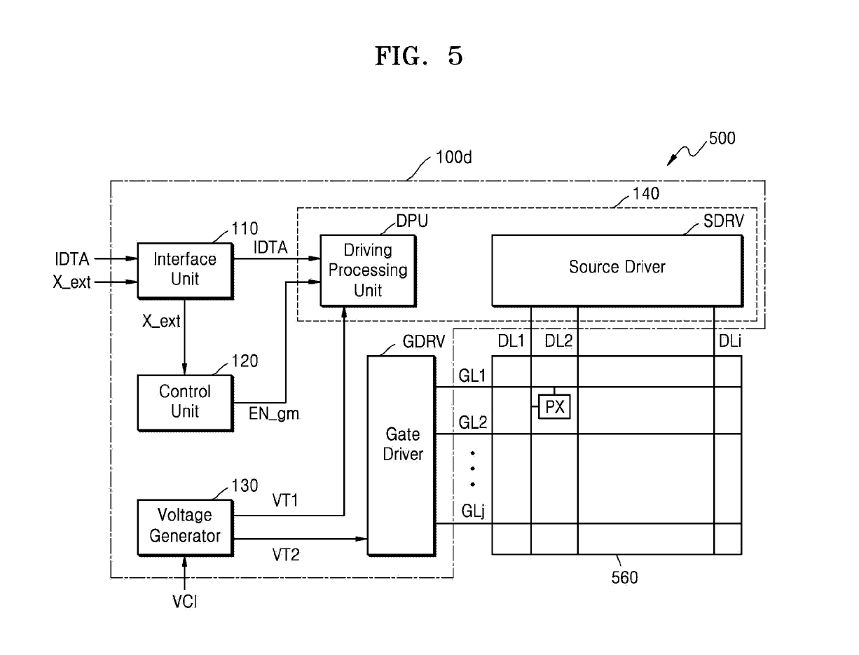

FIG. 5 illustrates an electronic device 500 according to some example embodiments. The electronic device 500 shown in FIG. 5 may be a display device. The electronic device 500 may include a display panel 560 and a display driver IC 100d.

The display panel 560 may display an image in units of frames, or may display an image according to other types of units. The display panel 560 may be implemented as one selected from among a liquid crystal display (LCD), a light-emitting diode (LED) display, an organic LED (OLED) display, an active-matrix OLED (AMOLED) display, an electrochromic display (ECD), a digital mirror device (DMD), an actuated mirror device (AMD), a grating light value (GLV), a plasma display panel (PDP), an electro-luminescent display (ELD), a vacuum-fluorescent display (VFD), etc. Additionally, the display panel 560 may also be implemented as a different type of flat-panel display from those described above, a flexible display, etc.

The display panel 560 may include a plurality of gate lines GL1 through GLj for transmitting a scanning signal in a direction of a row, a plurality of data lines DL1 through DLk that are disposed to cross the plurality of gate lines GL1 through GLj and transmit a driving voltage in a direction of a column, and a plurality of pixels PX that are disposed on an area in which the plurality of gate lines GL1 through GLj and the plurality of data lines DL1 through DLk cross each other.

If the plurality of gate lines GL1 through GLj are sequentially activated, a driving voltage DVLT may be applied to the pixels PX connected to the activated gate lines GL1 through GLj via the plurality of data lines DL1 through DLk. The driving voltage DVLT, in correspondence with color data included in input data IDTA, may be applied to each pixel PX of the display panel 560.

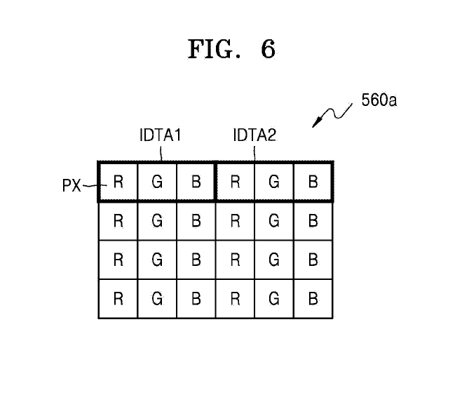

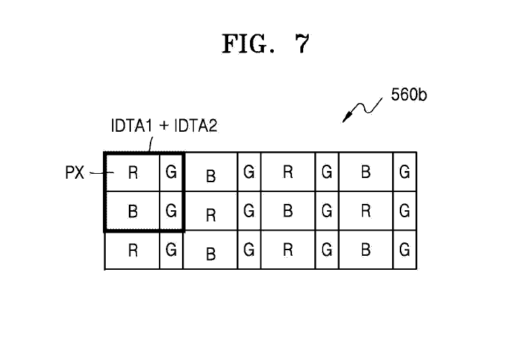

FIGS. 6 and 7 respectively illustrate display panels according to some example embodiments. According to an example embodiment, as shown in FIG. 6, three pixels PX of a display panel 560a may respectively display color data, such as R, B, and G data, with respect to each of input data IDTA1 and IDTA2. Additionally, according to another example embodiment, as shown in FIG. 7, two pixels PX of a display panel 560b may respectively display the color data R and B and other two pixels PX may display the color data G, with respect to a pair of the input data IDTA1 and IDTA2. The display panel 560b shown in FIG. 7 may be implemented so that a size of pixels that display the color data R and B is greater than a size of a pixel that displays the color data G. Hereinafter, the example embodiment where a display panel is implemented as shown in FIG. 6 will be described for the sake of convenience of description, however the inventive concepts are not limited thereto and may be applied to other situations/embodiments.

Referring back to FIG. 5, the display driver IC 100d may generate the driving voltage DVLT so that an image that corresponds to the input data IDTA is displayed on the display panel 560 by processing the input data IDTA. According to some example embodiments, the display driver IC 100d may be implemented as a chip or a plurality of chips. The display driver IC 100d may include an interface unit 110, the control unit 120, a voltage generating unit 130, the data processing unit 140, and a gate driver GDRV, but is not limited thereto.

The interface unit 110 may receive the external signal X_ext and the input data IDTA and respectively transmit the external signal X_ext and the input data IDTA to the control unit 120 and the data processing unit 140. However, as described with reference to FIG. 3, if the input data IDTA includes only a part of the color data is input, the interface unit 110 may process the input data IDTA as the external signal X_ert and may transmit the input data IDTA to the control unit 120. The interface unit 110 may receive the external signal X_ext and the input data IDTA by using one of an RGB interface, a CPU interface, a service provider interface (SPI), a mobile display digital interface (MDDI), a mobile industry processor interface (MIPI), or any other image and/or video interface. As described above, the control unit 120 may activate the gray mode signal EN_gm, based on the external signal X_ext transmitted from the interface unit 110. As described above, the data processing unit 140 may receive the gray mode signal EN_gm and may then operate in a gray mode, and thus, process the input data IDTA as gray data GDTA. The data processing unit 140 may include a driving processing unit DPU and a source driver SDRV.

The driving processing unit DPU may perform at least one selected from the group including compressing, storing, decompressing, image processing, etc. The source driver SDRV may convert the input data IDTA, which is digital data applied from the driving processing unit DPU, into an analog driving voltage DVLT and may output the input data IDTA to the data lines DL1 through DLk of the display panel 560. FIG. 5 illustrates at least one example embodiment in which one source driver SDRV is included. However, the source driver SDRV is not limited thereto, and two or more source drivers SDRV may be included.

The gate driver GDRV may sequentially scan the gate lines GL1 through GLj of the display panel 560. The gate driver GDRV may activate a selected gate line by applying a gate-on voltage to the selected gate line. The source driver SDRV may output a driving voltage DVLT that corresponds to pixels connected to the activated gate line so that an image may be displayed in units of horizontal lines of the display panel 560, that is, according to each row. According to an example embodiment, with regard to the electronic device 500, it is shown that the gate driver GDRV is included in the display driver IC 100d, but the gate driver GDRV is not limited thereto. For example, the gate driver GDRV may be included in the display panel 560 formed of low-temperature polysilicon (LTPS), etc.

The voltage generating unit 130 may receive a power voltage VCI from outside and may generate voltages VT1 and VT2 that are desired, useful, and/or necessary for the source driver 200 and the gate driver 300.

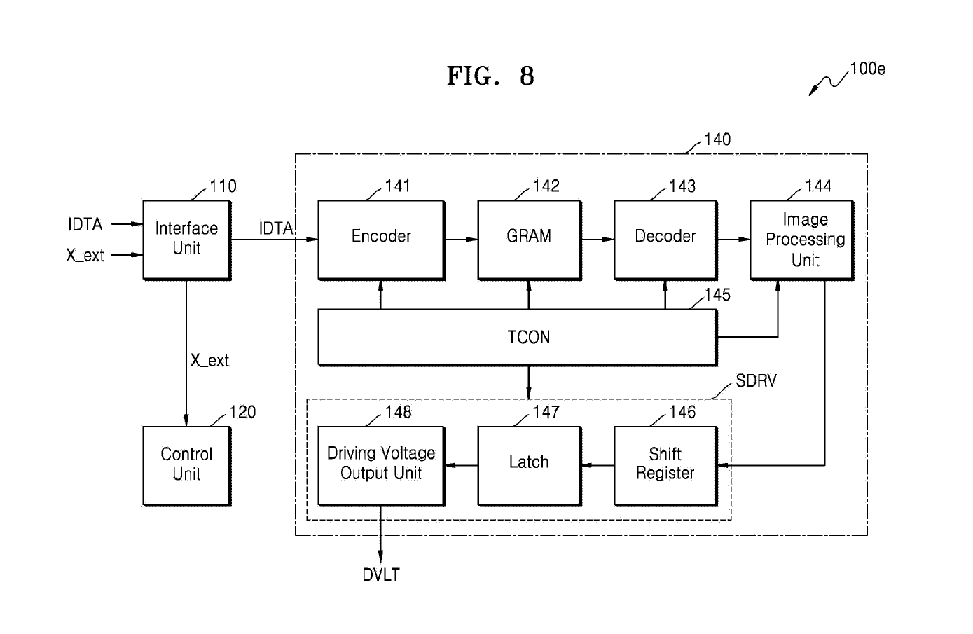

FIG. 8 illustrates a display driver IC 100e according to some example embodiments. Referring to FIG. 8, the display driver IC 100e may include the interface unit 110, the control unit 120, and the data processing unit 140. The interface unit 110 may respectively transmit the external signal X_ext and the input data IDTA, which are input to the interface unit 110, to the control unit 120 and the data processing unit 140. The control unit 120 may activate the gray mode signal EN_gm based on the external signal X_ext transmitted by the interface unit 110. As described above, the data processing unit 140 may receive the gray mode signal EN_gm and may operate in a gray mode, and thus, process the input data IDTA as gray data GDTA.

According to some example embodiments, the data processing unit 140 may include an encoder 141, a graphics memory 142, a decoder 143, an image processing unit 144 (i.e., an image processor), a timing controller 145, and the source driver SDRV. The source driver SDRV may include a shift register 146, a latch 147, and a driving voltage output unit 148.

An operation of the data processing unit 140 in a normal mode is described. The encoder 141 may compress input data IDTA transmitted from the interface unit 110. For example, the encoder 141 may compress the input data IDTA to ⅓ of an original size of the input data IDTA. The compressed input data IDTA may be stored in the graphics memory 142. The graphics memory 142 may store the input data IDTA that is compressed in units of frames, or compressed using other types of data units. Additionally, the graphics memory 142 may include a greater number of rows than the number of horizontal lines in a frame. The input data IDTA compressed and stored in the graphics memory 142 may be decompressed by the decoder 143, and then, transmitted to the image processing unit 144. The image processing unit 144 may perform an image processing on the input data IDTA. For example, the image processing unit 144 may perform at least one image processing selected from the group including, for example, contrast, enhancement, saturation, sharpness on the input data IDTA, etc.

The timing controller 145 may control operation timing of the encoder 141, the graphics memory 142, the decoder 143, the image processing unit 144, and the like. Additionally, the timing controller 145 may control operation timing of the shift register 146, the latch 147, and the driving voltage output unit 148, which may be included in the source driver SDRV. The shift register 146 may include a plurality of registers that are connected to each other in series, and thus may shift the image-processed input data IDTA that is sequentially input to the shift register 146. Additionally, the shift register 146 may also include a plurality of registers that are connected to each other in parallel, for use in parallel and/or buffered image-processing operations.

For example, the shift register 146 may include the same number of registers as the number of horizontal lines in a display panel. For example, if the display panel 560a is a full high-definition (HD) display panel having a structure shown in FIG. 6, each horizontal line would include 3×1080 pixels PX, and the shift register 146 may include 3×1080 registers and may shift the image-processed input data IDTA that is sequentially input to the shift register 146. When the input data IDTA that corresponds to one horizontal line and is sequentially input to the shift register 146 is all stored in the shift register 146, the input data IDTA may be all output from the shift register 146 to the latch 147. Input data IDTA stored in the latch 147 may be processed as the driving voltage DVLT via the driving voltage output unit 148.

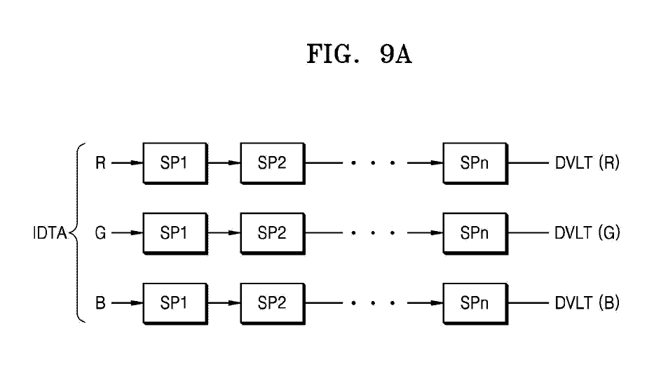

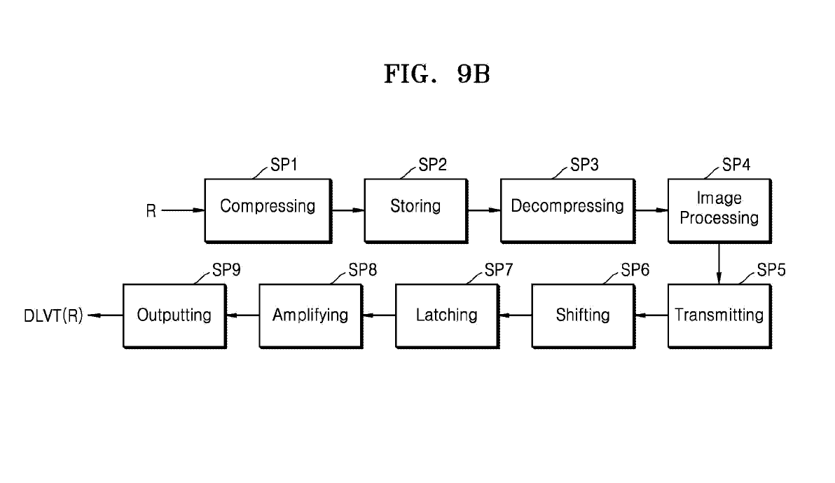

FIGS. 9A and 9B respectively illustrate example embodiments of a data path in a normal mode. Referring to FIG. 9A, a driving voltage DVLT that may correspond respectively to color data, for example, R, G, and B, of input data IDTA may be generated via n sub-paths SP1 through SPn in the normal mode.

As shown in FIG. 9B, color data R, G, and B of input data IDTA may be respectively processed as a driving voltage DVLT for driving a display panel, via a data path that includes as sub-paths compressing SP1 performed by using the encoder 141, storing SP2 in the graphics memory 142, decompressing SP3 performed by the decoder 143, image processing SP4 performed by the image processing unit 144, transmitting SP5 of the image-processed input data IDTA to the source driver SDRV, shifting SP6 performed on sequentially-input color data by the shift register 146, latching SP7 of the input data IDTA from the shift register 146 to the latch 147, and amplifying SP8 and outputting SP9 performed by the driving voltage output unit 148, which are shown in FIG. 8. However, in the normal mode, a data path may be also formed of different sub-paths from the sub-paths shown in FIG. 9B.

The data processing unit 140 for processing color data, such as R, G, and B data, of input data IDTA in a normal mode as a driving voltage via the data path shown in FIG. 9A or 9B may deactivate at least one sub-path selected from sub-paths that form a data path respectively with regard to the color data, such as R, G, and B, in response to a gray mode signal EN_gm. For example, the data processing unit 140 may deactivate a sub-path SPn with respect to the color data G and B in a gray mode and generate a driving voltage DVLT for the color data G and B by using a sub-path SPn for the color data R. Accordingly, the data processing unit 140 may process the input data IDTA as gray data GDTA, that is, as gray data GDTA in which the color data R, G, and B of the input data IDTA has the same driving voltage DVLT.

As such, according to some example embodiments of a display driver IC, some sub-paths are deactivated or omitted when input data for displaying an image is processed, and thus, power consumption may be reduced. Hereinafter, various embodiments for implementing a gray mode are described.

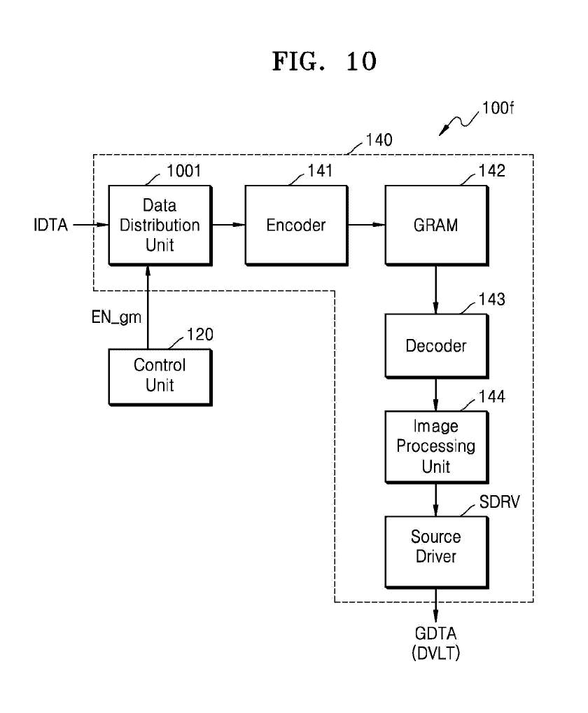

FIG. 10 illustrates a display driver IC 100f according to some example embodiments. Referring to FIG. 10, the display driver IC 100f includes the control unit 120 and the data processing unit 140. The control unit 120 may activate a gray mode signal EN_gm based on an external signal X_ext. The data processing unit 140 may process input data IDTA as gray data GDTA in a gray mode in response to the gray mode signal EN_gm. For this, the data processing unit 140 may include a data distribution unit 1001, the encoder 141, the graphics memory 142, the decoder 143, the image processing unit 144, and the source driver SDRV. The encoder 141, the graphics memory 142, the decoder 143, the image processing unit 144, and the source driver SDRV are already described above, and thus, a detailed description thereof is not provided here.

The data distribution unit 1001 may transmit all of color data, such as R, G, and B data, of the input data IDTA to the encoder 141 in a normal mode. Accordingly, the encoder 141, the graphics memory 142, the decoder 143, the image processing unit 144, and the source driver SDRV may generate a driving voltage DVLT respectively for the color data, such as R, G, and B data, of the input data IDTA in the normal mode.

The data distribution unit 1001 may transmit only a part of the color data, such as R, G, and B data, of the input data IDTA to the encoder 141 in the gray mode. For example, the data distribution unit 1001 may transmit only the color data R of the input data IDTA to the encoder 141, in response to the gray mode signal EN_gm. Accordingly, in the gray mode, the encoder 141, the graphics memory 142, the decoder 143, the image processing unit 144, and the source driver SDRV may generate a driving voltage DVLT only for the color data R of the input data IDTA and drive pixels PX for the color data R, G, and B by using the driving voltage DVLT for the color data R. Even when the input data IDTA is input as one piece of color data, the data processing unit 140 may perform processing as follows, according to at least one example embodiment:

The data distribution unit 1001 may transmit only the color data G or B of the input data IDTA to the encoder 141, in response to the gray mode signal EN_gm. However, hereinafter, an example in which a sub-path deactivated in a gray mode is a sub-path of color data G or B is described.

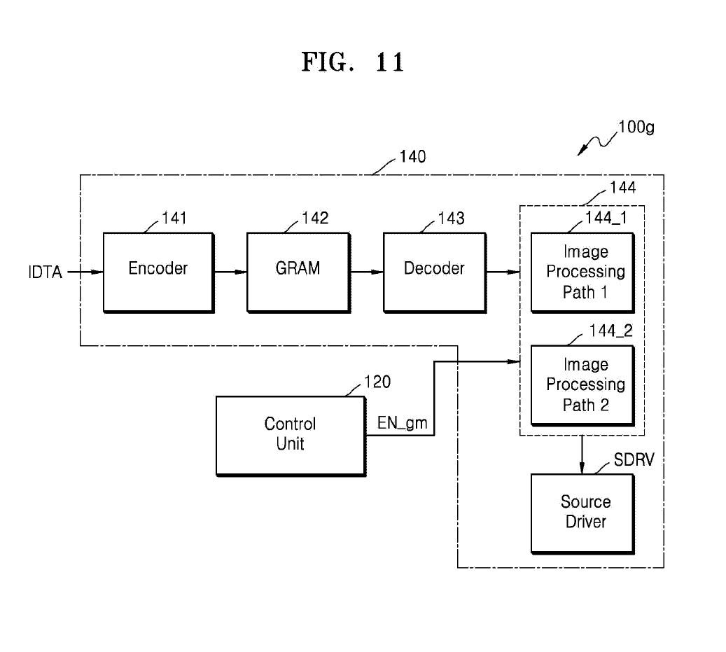

FIG. 11 illustrates a display driver IC 100g according to some example embodiments. Referring to FIG. 11, the display driver IC 100g includes the control unit 120 and the data processing unit 140. The control unit 120 may activate a gray mode signal EN_gm based on an external signal X_ext. The data processing unit 140 may process input data IDTA as gray data GDTA in a gray mode in response to the gray mode signal EN_gm. For this, the data processing unit 140 may include the encoder 141, the graphics memory 142, the decoder 143, the image processing unit 144, and the source driver SDRV. The encoder 141, the graphics memory 142, the decoder 143, and the source driver SDRV are already described above, and thus, a detailed description thereof is not provided here.

The image processing unit 144 may perform image processing respectively on color data, such as R, G, and B data, of the input data IDTA via a first image processing path 144_1 in a normal mode. On the contrary, image processing may be performed via a second image processing path 144_2 in response to the gray mode signal EN_gm.

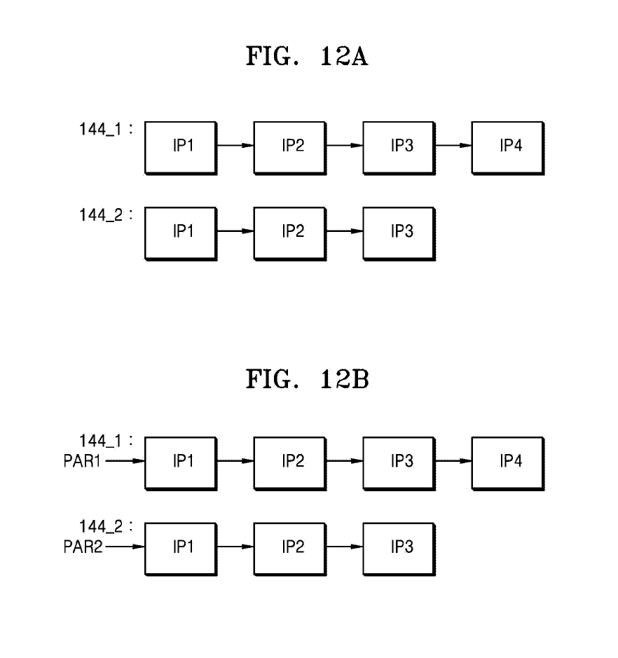

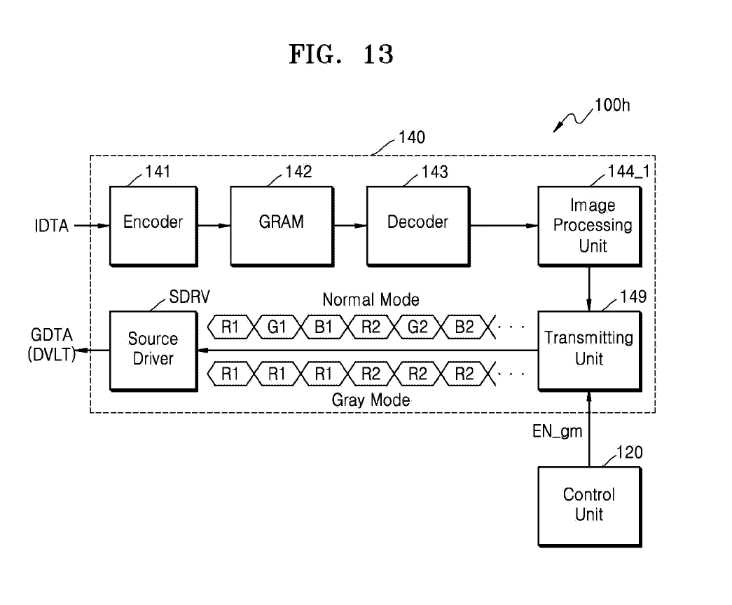

As shown in FIG. 12A, image processing may be performed in the first image processing path 144_1 by using four intellectual property blocks (IPs), but is not limited thereto and may include more or less IPs. The four IPs may respectively be an IP for performing one or more image processing capabilities selected from among contrast, enhancement, saturation, sharpness, etc. Additionally, image processing may be performed in the second image processing path 144_2 by using some IPs selected from among the four IPs shown in FIG. 12A. For example, the second image processing path 144_2 may be a path in which an IP for performing sharpness in the first image processing path 144_1 is deactivated.

Additionally, image processing may be performed in the first image processing path 144_1 by using, for example, the four IPs that are set as a first parameter PAR1 shown in FIG. 12B. Furthermore, image processing may be performed in the second image processing path 144_2 by, for example, using four IPs set as a second parameter PAR2 shown in FIG. 12B. As described above, the four IPs shown in FIG. 12B may be an IP for performing one or more image processing capabilities, such as contrast, enhancement, saturation, sharpness, etc. However, a degree of image processing may vary with set parameters. For example, an IP for performing contrast may perform contrast more strongly on the input data IDTA when the IP is set as a second parameter, compared to when the IP is set as a first parameter.

FIG. 13 illustrates a display driver IC 100h according to some example embodiments. Referring to FIG. 13, the display driver IC 100f may include the control unit 120 and the data processing unit 140. The control unit 120 may activate a gray mode signal EN_gm based on an external signal X_ext. The data processing unit 140 may process input data IDTA as gray data GDTA in a gray mode in response to the gray mode signal EN_gm. For this, the data processing unit 140 may include the encoder 141, the graphics memory 142, the decoder 143, the image processing unit 144-1, and the source driver SDRV.

The data processing unit 140 may further include a transmitting unit 149 for transmitting image-processed input data IDTA to the source driver SDRV. The transmitting unit 149 may transmit color data, such as R, G, and B data, of the image-processed image data IDTA sequentially to the source driver SDRV in a normal mode. For example, in a normal mode, the transmitting unit 149 may sequentially transmit color data R1, G1, and B1 included in one piece of input data to the source driver SDRV, and then, sequentially transmit color data R2, G2, and B2 included in another piece of input data to the source driver SDRV.

On the contrary, the data distribution unit 1001 may transmit only the color data R of the input data IDTA to the encoder 141, in response to the gray mode signal EN_gm. FIG. 13 shows an example of transmitting the color data R of the input data IDTA, instead of the color data G and B of the input data IDTA, to the source driver SDRV. For example, the transmitting unit 149 may sequentially transmit color data R1 included in one piece of input data to the source driver SDRV three times, and then, sequentially transmit color data R2 included in another piece of the input data to the source driver SDRV three times, in response to the gray mode signal EN_gm.

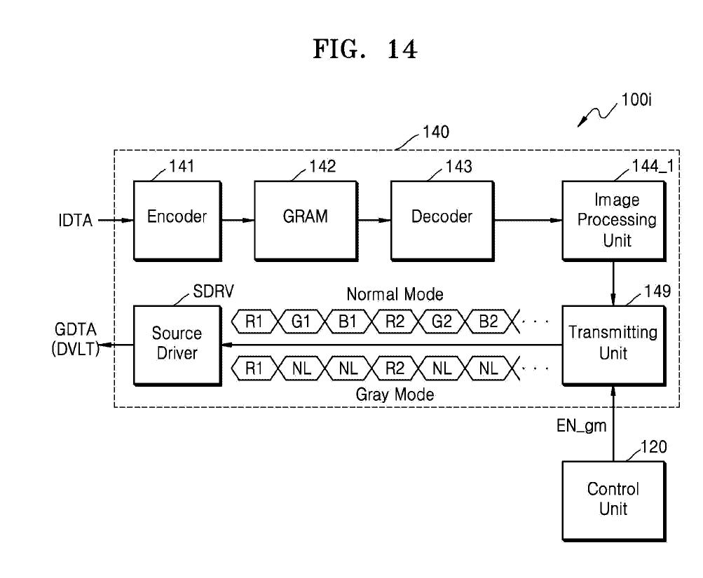

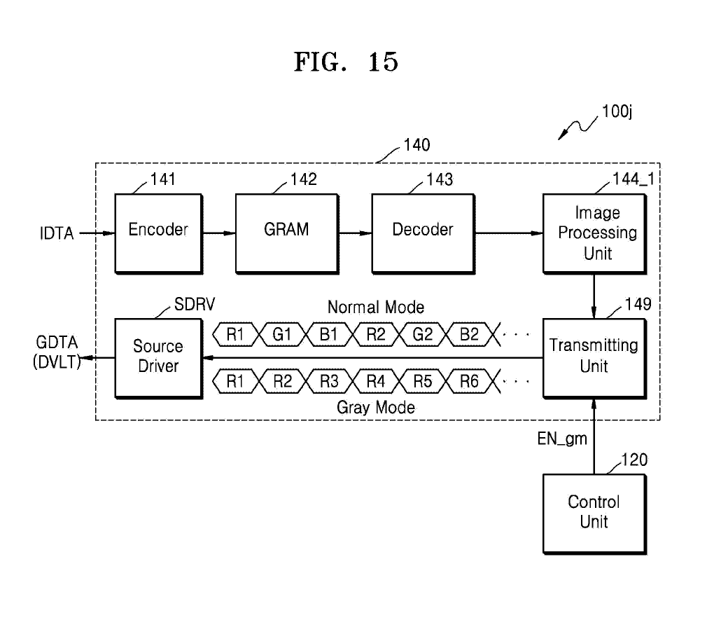

However, example embodiments are not limited thereto. The transmitting unit 149 included in a display driver IC 100i shown in FIG. 14 may output a null value NL instead of color data G and B of input data IDTA, in response to a gray mode signal EN_gm. The transmitting unit 149 may transmit color data R1 included in one piece of input data and two null values NL sequentially to the source driver SDRV, and then, transmit color data R2 included in another piece of input data and two null values NL sequentially to the source driver SDRV. Additionally, the transmitting unit 149 included in a display driver IC 100j shown in FIG. 15 may output only color data R of input data IDTA, in response to a gray mode signal EN_gm. The transmitting unit 149 may sequentially transmit color data R1, R2, and R3 included in each image data to the source driver SDRV.

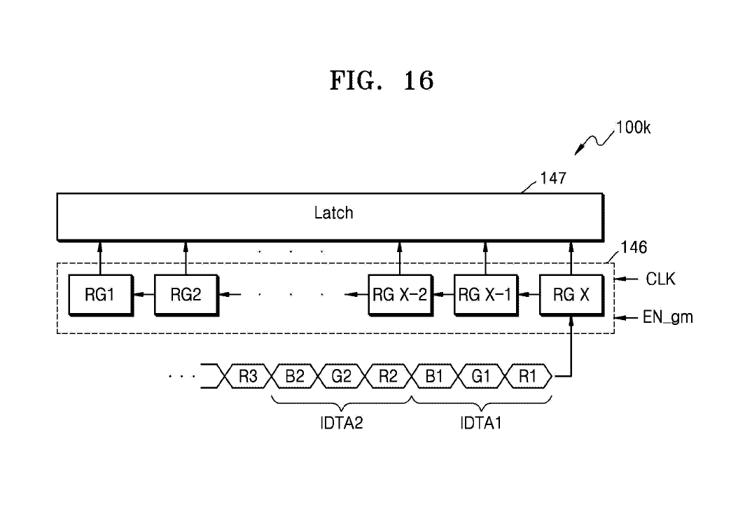

FIG. 16 illustrates a display driver IC 100k according to some example embodiments. As described above, the shift register 146 included in the display driver IC 100k, shown in FIG. 16, may include a plurality of registers RG1 through RGx. The shift register 146 may include the plurality of registers RG1 through RGx that are connected to each other in series, and thus shift image-processed input data IDTA that is sequentially input to the shift register 146. For example, the shift register 146 may include the same number of registers to correspond to the number of horizontal lines in a display panel, but is not limited thereto. If the number of pixels that constitute one horizontal line of the display panel is x, the shift register 146 may include x registers RG1 through RGx.

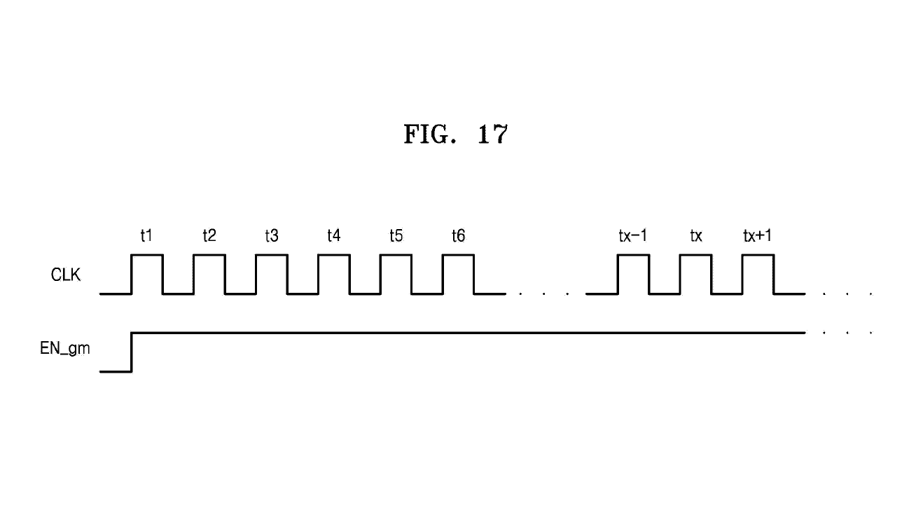

In a normal mode, the shift register 146 may shift color data, such as R, G, and B data, of input data IDGA that is sequentially input to the shift register 146. For example, whenever a clock signal CLK transitions to logic high, the color data R, G, and B of the input data IDTA, which is sequentially input, may be shifted. For example, if a clock signal CLK transitions to logic high at times t1, t2, and t3, as shown in FIG. 17, color data R1 of input data IDTA1 may shift to a register RGx-2, color data G1 of the input data IDTA1 may shift to a register RGx-1, and color data B1 of the input data IDTA1 may shift to a register RGx respectively. When the clock signal CLK transitions to logic high at a time tx, all color data that constitutes one horizontal line may shift to the x registers RG1 through RGx. The x registers RG1 through RGx may all transmit color data to a latch.

The shift register 146 may deactivate shifting of the color data G and B of the input data IDTA, in response to the gray mode signal EN-gm. For example, if the gray mode signal EN_gm is activated at the time t1 shown in FIG. 17, the shift register 146 may shift only the color data R of the input data IDTA. In this case, when the clock signal CLK transitions to logic high at the times t1, t2, and t3 shown in FIG. 17, the color data R1 of the input data IDTA1 may shift to the register RGx-2 and the color data G1 and B1 of the input data IDTA1 may not shift.

If color data of the input data IDTA is input as shown in FIGS. 13 through 15, the shift register 146 may operate as follows, according to some example embodiments: if color data is input as shown in FIG. 13 or 14, the shift register 146 may perform shifting whenever the clock signal CLK transitions to logic high, regardless of whether the gray mode signal EN_gm is activated or not. Additionally, if color data is input as shown in FIG. 15, the shift register 146 may perform shifting whenever the clock signal CLK transitions to logic high three times, in response to the gray mode signal EN_gm.

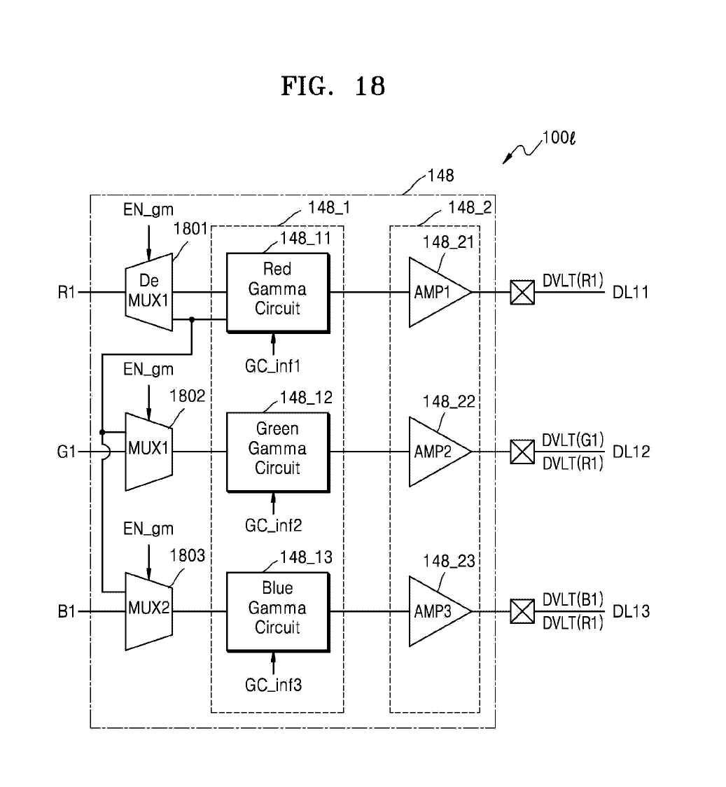

FIG. 18 illustrates a display driver IC 1001 according to some example embodiments. FIG. 18 shows the driving voltage output unit 148 for one piece of input data. For example, if 1080 pieces of input data are displayed on each horizontal line of a display panel, the driving voltage output unit 148 may include 1080 structures as each shown in FIG. 18. This also applies to a driving voltage output unit according to another example embodiment, which is to be described below.

The driving voltage output unit 148 included in the display driver IC 1001, shown in FIG. 18, generates and outputs a driving voltage DVLT respectively with regard to color data, such as R1, G1, and B1 data, of input data IDTA1 in a normal mode. Additionally, the driving voltage output unit 148 may generate the driving voltage DVLT only for the color data R1 of the input data IDTA1 and display the color data G1 and B1 of the input data IDTA1 by using the driving voltage DVLT for the color data R1.

In order to perform such an operation, the driving voltage output unit 148 may include a first demultiplexer 1801, first and second multiplexers 1802 and 1803, a gamma circuit unit 148_1, and an amplifying unit 148_2, but is not limited thereto. The first demultiplexer 1801 and the first and second multiplexers 1802 and 1803 may respectively transmit the color data, such as R1, G1, and B1 data, of the input data IDTA1 to the gamma circuit unit 1481 in a normal mode. The first demultiplexer 1801 may transmit the color data R1 of the input data IDTA1 to the gamma circuit unit 148_1, and the first and second multiplexer 1802 and 1803, in response to the gray mode signal EN_gm. The first and second multiplexers 1802 and 1803 may transmit the color data R1 of the input data IDTA1 to the gamma circuit unit 148_1, in response to the gray mode signal EN_gm.

The gamma circuit unit 148_1 may convert input color data into a gamma-corrected analog voltage, based on gamma curve information that represents a gamma curve. The gamma circuit unit 148_1 may include a plurality of gamma circuits, such as red gamma circuit 148_11, a green gamma circuit 148_12, and a blue gamma circuit 148_13. In the normal mode, the gamma circuit 148_1 operates as follows, according to some example embodiments: The red gamma circuit 148_11 converts the color data R1 into a gamma-corrected analog voltage, based on red gamma curve information GC_inf1. The green gamma circuit 148_12 converts the color data G1 into a gamma-corrected analog voltage, based on green gamma curve information GC_inf2. The blue gamma circuit 148_13 converts the color data B1 into a gamma-corrected analog voltage, based on blue gamma curve information GC_inf3.

Additionally, the gamma circuit unit 148_1 operates in a gray mode as follows, according to some example embodiments: The red gamma circuit 148_11 converts the color data R1 into a gamma-corrected analog voltage, based on the red gamma curve information GC_inf1. The green gamma circuit 148_12 converts the color data R1 into a gamma-corrected analog voltage, based on the green gamma curve information GC_inf2. The blue gamma circuit 148_12 converts the color data R1 into a gamma-corrected analog voltage, based on the blue gamma curve information GC_inf3.

Amplifiers 148_21, 148_22, and 148_23 included in the amplifying unit 148_2 may respectively apply a driving voltage, obtained by amplifying the color data, such as R1, G1, and B1 data, of the input data IDTA1, which are gamma corrected and converted into an analog voltage, to a terminal or a pad in a normal mode. For example, a driving voltage DVLT which corresponds to the color data R1, G1, and B1 of the input data IDTA1 may be applied to data lines DL11, DL12, and DL13 connected to a terminal or a pad in the normal mode. A driving voltage DVLT (R1) for the color data R1 may be applied to the data line DL11, a driving voltage DVLT (G1) for the color data G1 may be applied to the data line DL12, and a driving voltage DVLT (B1) for the color data B1 may be applied to the data line DL13 respectively. Pixels connected to the data lines DL11, DL12, and DL13 may be driven respectively by the driving voltages DVLT (R1), DVLT (G1), and DVLT (B1).

The amplifiers 148_21, 148_22, and 148_23 included in the amplifying unit 148_2 may apply a driving voltage, obtained by amplifying color data, such as R1 of the gamma-corrected input data IDTA1, to a terminal or a pad respectively in a gray mode. For example, the driving voltage DVLT (R1) for the color data R1 may be applied respectively to the data lines DL11 through DL13. Accordingly, pixels connected to the data lines DL11, DL12, and DL13 may be driven by the driving voltage DVLT (R1). Thus, a display panel may display gray data in a gray mode. Accordingly, power consumption of the display driver IC 1001 or an electronic device that includes the display driver IC 1001 is reduced.

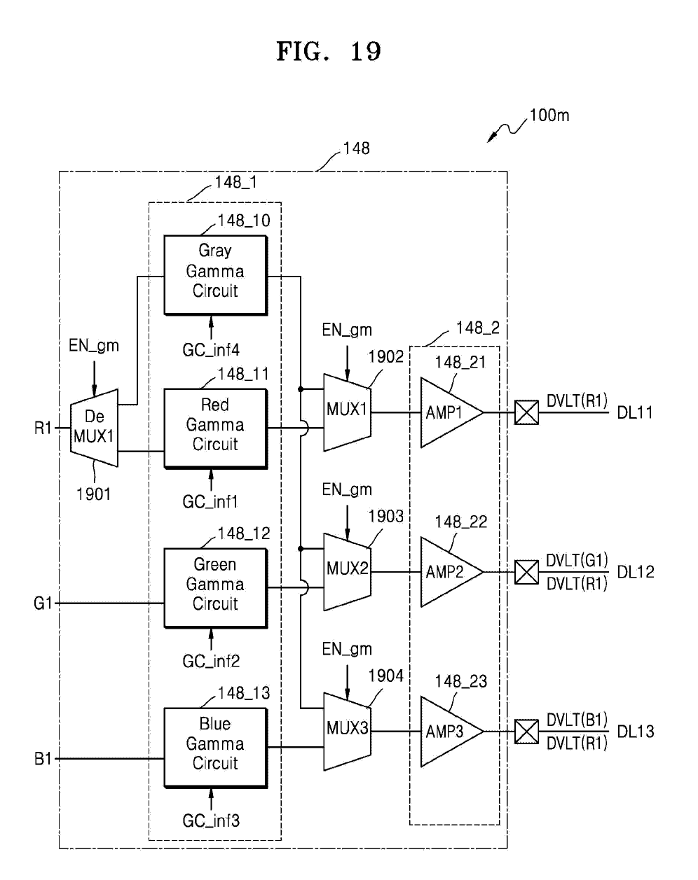

FIG. 19 illustrates a display driver IC 100m according to some example embodiments. The driving voltage output unit 148 included in the display driver IC 100m, shown in FIG. 19, may generate and output a driving voltage DVLT respectively with regard to color data, such as R1, G1, and B1 data, of input data IDTA1 in a normal mode. Additionally, the driving voltage output unit 148 may generate only a driving voltage DVLT for the color data R1 of the input data IDTA1 and display the color data G1 and B1 of the input data IDTA1 by using the driving voltage DVLT for the color data R1 in a gray mode.

In order to perform such an operation, the driving voltage output unit 148 may include a first demultiplexer 1901, first through third multiplexers 1902 through 1904, the gamma circuit unit 148_1, and the amplifying unit 148_2, according to at least one example embodiment. Color data, such as R1, G1, and B1 data, of the input data IDTA1 may be respectively transmitted to the gamma circuit unit 148_1 in a normal mode. An operation of the gamma circuit unit 148_1, and the amplifying unit 148_2 in the normal mode are described above, and thus, a detailed description thereof will not be provided here.

The gamma circuit unit 148_1 shown in FIG. 19 may further include a gray gamma circuit 148_10. The gamma circuit unit 148_10 may convert input color data into a gamma-corrected analog voltage, based on gray gamma curve information GC_inf4 that indicates information about gamma correction adaptive to a gray color. For example, the first demultiplexer 1901 may transmit the color data R1 of the input data IDTA1 to the gamma circuit unit 148_10, in response to the gray mode signal EN_gm. Accordingly, gamma correction adaptive to gray color may be performed on the color data R1 of the input IDTA1. The first through third multiplexers 1902 through 1904 may respectively apply color data R1, which is gamma-corrected by the gray gamma circuit 148_10, to the amplifying unit 148_2 in response to the gray mode signal EN_gm.

The amplifiers 148_21, 148_22, and 148_23 included in the amplifying unit 148_2 may respectively apply a driving voltage, obtained by amplifying the color data R1 of the input data IDTA1 gamma-corrected by the gray gamma circuit 148_10, to a terminal or a pad in a gray mode. In detail, a driving voltage DVLT (R1) for the color data R1 may be applied to the data lines DL11 through DL13. Thus, in the gray mode, a display panel may display gray data.

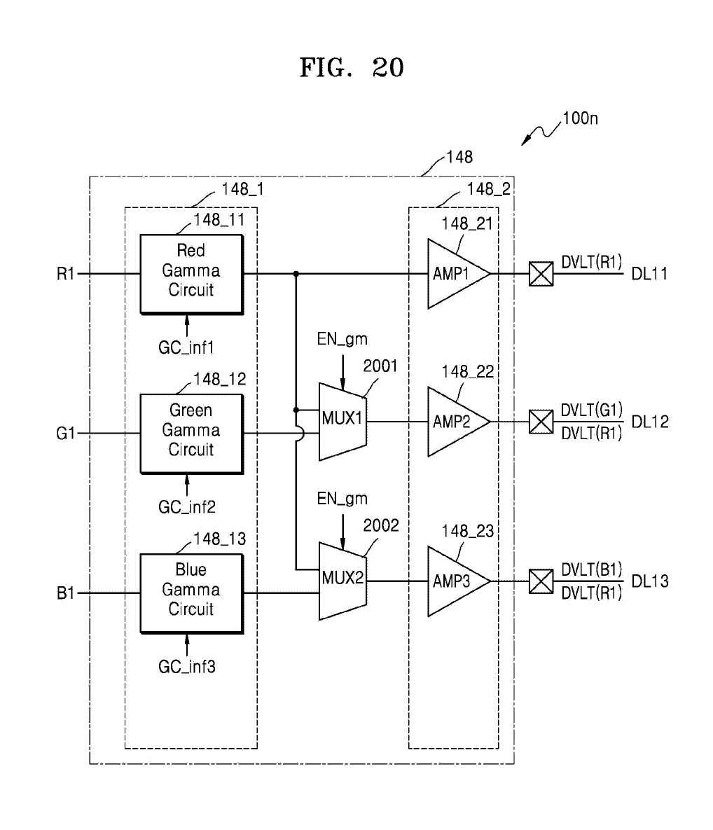

FIG. 20 illustrates a display driver IC 100n according to another example embodiment. The driving voltage output unit 148 included in the display driver IC 100n, shown in FIG. 20, may generate and output a driving voltage DVLT respectively for color data, such as R1, G1, and B1 data, of input data IDTA1 in a normal mode. Additionally, the driving voltage output unit 148 may generate the driving voltage DVLT only for the color data R1 of the input data IDTA1 and display the color data G1 and B1 of the input data IDTA1 by using the driving voltage DVLT for the color data R1 in the gray mode.

In order to perform such an operation, the driving voltage output unit 148 may include first and second multiplexers 2001 and 2002, the gamma circuit unit 148_1, and the amplifying unit 148_2. The color data, such as R1, G1, and B1 data, of the input data IDTA1 may be respectively transmitted to the gamma circuit unit 148_1. For example, the red gamma circuit 148_11 converts the color data R1 into a gamma-corrected analog voltage, based on red gamma curve information GC_inf1, the green gamma circuit 148_12 converts the color data G1 into a gamma-corrected analog voltage, based on green gamma curve information GC_inf2, and the blue gamma circuit 148_13 converts the color data B1 into a gamma-corrected analog voltage, based on blue gamma curve information GC_inf3.

The first and second multiplexers 2001 and 2002 may transmit the color data, such as R1, G1, and B1 data, of the input data IDTA1, which are gamma-corrected respectively by a plurality of gamma circuits, such as the red gamma circuit 148_11, the green gamma circuit 148_12, and the green gamma circuit 148_13, to the amplifying unit 148_2 in a normal mode. An operation of and the amplifying unit 148_2 in a normal mode is described above, and thus, a detailed description thereof will not be provided here.

Additionally, the first and second multiplexers 2001 and 2002 may transmit only the color data R1 of the input data IDTA1, which is gamma-corrected by the red gamma circuit 148_11, to the amplifying unit 148_2 in response to the gray mode signal EN_gm. The amplifiers 148_21, 148_22, and 148_23 included in the amplifying unit 148_2 may respectively apply a driving voltage, obtained by amplifying the color data R1 of the input data IDTA1 which is gamma corrected by the red gamma circuit 148_11, to a terminal or a pad in a gray mode. In detail, a driving voltage DVLT (R1) for the color data R1 may be applied respectively to the data lines DL11, DL12, and DL13. Pixels connected to the data lines DL11, DL12, and DL13 may be driven respectively by the driving voltages DVLT (R1). Thus, a display panel may display gray data.

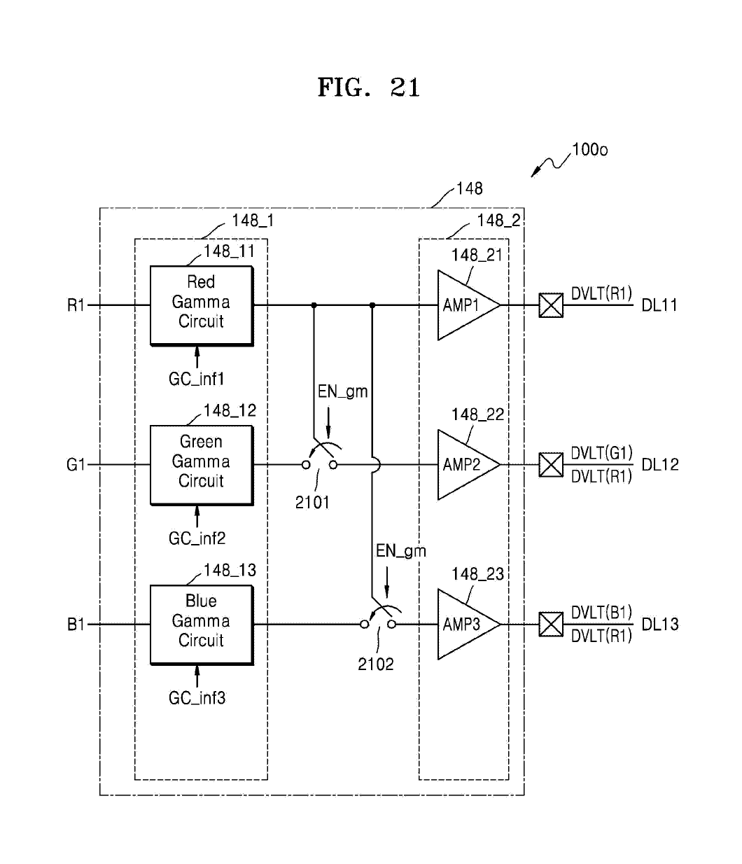

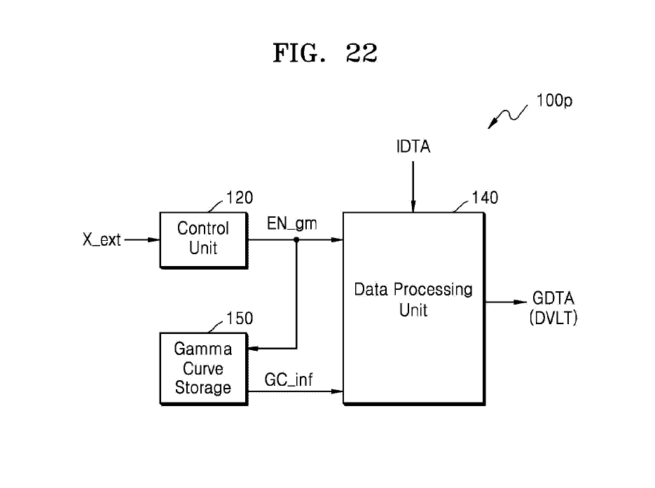

An example embodiment in which a demultiplexer or a multiplexer is included to differentiate selection of a path according to a normal mode or a gray mode is described. However, embodiments are not limited thereto. Like a display driver IC 100o shown in FIG. 21, switches 2101 and 2102 may be included. Whereas the switches 2101 and 2102 respectively transmit color data, such as R1, G1, and B1 data, of gamma-corrected input data IDTA1 to the amplifying unit 148_2 in a normal mode, the switches 2101 and 2102 may transmit only the color data R1 of the gamma-corrected input data IDTA1 to the amplifying unit 148_2, in response to a gray mode signal EN_gm in a gray mode.

FIG. 22 illustrates a display driver IC 100p according to another example embodiment. The display driver IC 100p shown in FIG. 22 may further include a gamma curve storage unit 150 for storing gamma curve information GC_inf, as well as the control unit 120 and the data processing unit 140. For example, the gamma curve information GC_inf may include red gamma curve information GC_inf1, green gamma curve information GC_inf2, blue gamma curve information GC_inf3, and gray gamma curve information GC_inf4. The gamma curve information GC_inf may be a bit of a digital signal.

The gamma storage unit 150 may store the gamma curve information GC_inf in the form of a table. For example, the gamma curve storage unit 150 may transmit the red gamma curve information GC_inf1, the green gamma curve information GC_inf2, the blue gamma curve information GC_inf3, or the gray gamma curve information GC_inf4 to the data processing unit 140. In the gray mode, the gamma curve storage unit 150 may transmit the gray gamma curve information GC_inf4 to the data processing unit 140 in response to the gray mode signal EN_gm.

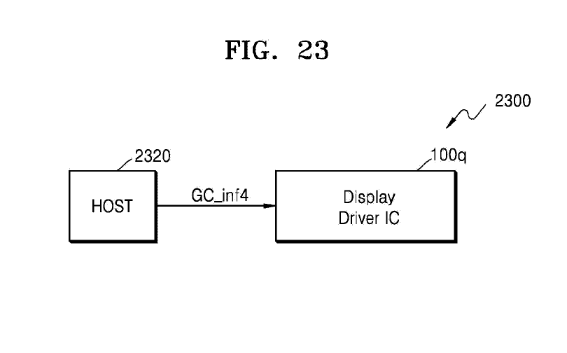

FIG. 23 illustrates an electronic device 2300 according to some example embodiments. The electronic device 2300 shown in FIG. 23 may include a host 2320 and a display driver IC 100q. The display driver IC 100q may receive gray gamma curve information GC_inf4 that may be used in a gray mode from the host 2320, instead of additionally storing the gray gamma curve information GC_inf4.

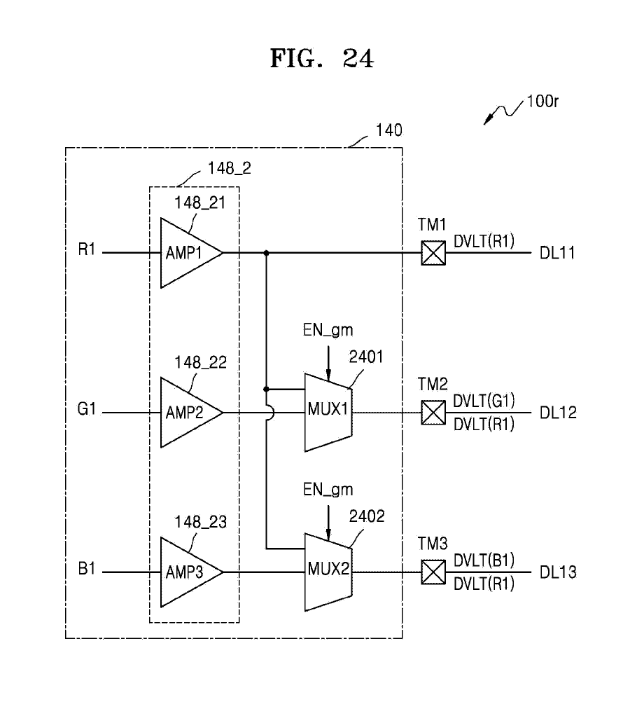

FIG. 24 illustrates a display driver IC 100r according to some example embodiments. For example, color data, such as R1, G1, and B1 data, applied to the amplifying unit 148_2 included in the data processing unit 140 in the display driver IC 100r may be data (or a voltage) on which compressing, storing, decompressing, image processing, shifting, latching, gamma-correction, etc., may be performed. However, color data R1, G1, and B1 is not limited thereto, and the amplifying unit 148_2 may amplify color data R1, G1, and B1 on which at least one selected from the group including the compressing, the storing, the decompressing, the image processing, the shifting, the latching, and the gamma-correction is not performed, or on which another processing is complementarily or additionally performed, and output the color R1, G1, and B1 as a driving voltage DVLT.

First and second multiplexers 2401 and 2402 included in the display driver IC 100r, shown in FIG. 24, may apply a driving voltage, output from the amplifiers 148_21, 148_22, and 148_23, to terminals TM1, TM2, and TM3 corresponding thereto in a normal mode. For example, a driving voltage DVLT (R1) for the color data R1 may be applied to a data line DL11, a driving voltage DVLT (G1) for the color data G1 may be applied to a data line DL12, and a driving voltage DVLT (B1) for the color data B1 may be applied to a data line DL13 respectively. Pixels connected to the data lines DL11, DL12, and DL13 may be driven respectively by the driving voltages DVLT (R1), DVLT (G1), and DVLT (B1).

The first and second multiplexers 2401 and 2402 included in the display driver IC 100r, shown in FIG. 24, may respectively apply only the driving voltage DVLT for the color data, such as R1 data, output from the amplifier 148_21, from among driving voltages output from the amplifiers 148_21, 148_22, and 148_23, to terminals TM1, TM2, and TM3, in response to the gray mode signal EN_gm. For example, only the driving voltage DVLT (R1) for the color data R1 may be applied respectively to the data lines DL11 through DL13 which are electrically connected to the terminals TM1, TM2, and TM3. Accordingly, pixels connected to the data lines DL11, DL12, and DL13 may be driven respectively by the driving voltages DVLT (R1). Thus, a display panel may display gray data in the gray mode.

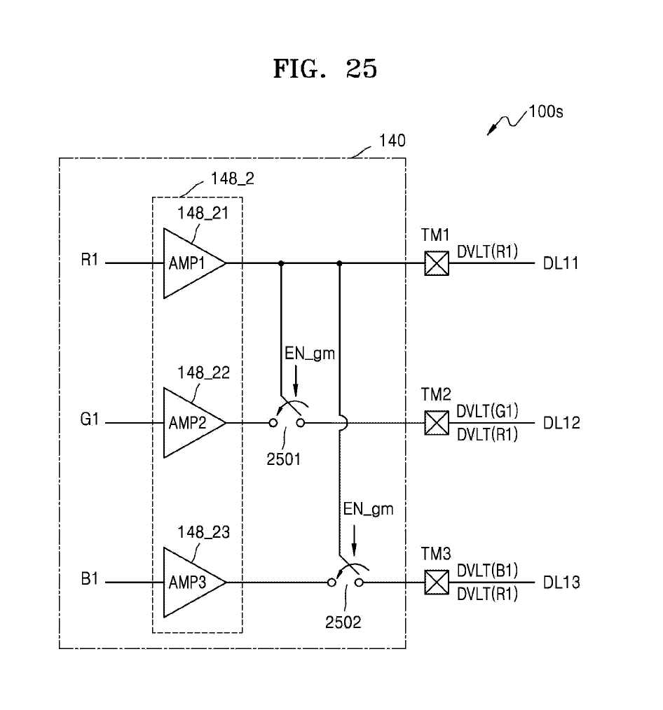

The first and second multiplexers 2401 and 2402 included in the display driver IC 100r, shown in FIG. 24, may be substituted by first and second switches 2501 and 2502 included in a display driver IC 100s shown in FIG. 25.

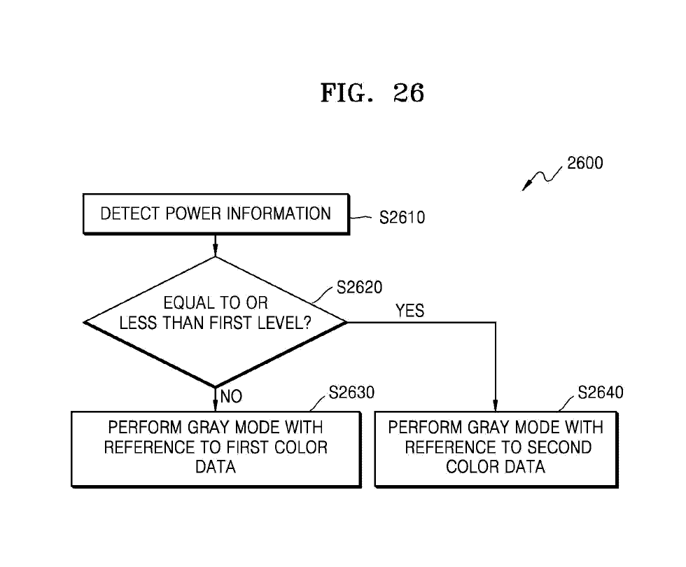

FIG. 26 illustrates a method 2600 of controlling a display driver IC in a gray mode, according to an example embodiment. According to an example embodiment, the method 2600 of controlling a display driver IC is performed assuming that a display driver IC operates in the gray mode. This also applies to a method of controlling a display driver IC in a gray mode according to some other example embodiments.

The method 2600 of controlling a display driver IC includes detecting power information in operation S2610, checking if power of an electronic device that includes the display driver IC is equal to or less than a first level based on the power information in operation S2620, performing a gray mode with reference to first color data in operation S2630, which is performed by the display driver IC if the power of the electronic device is not equal to or less than the first level (in a case of NO in operation S2620), and performing the gray mode with reference to second color data in operation S2640, which is performed by the display driver IC if the power of the electronic device is equal to or less than the first level (in a case of YES in operation S2620). The performing of the gray mode with reference to the first color data may include displaying remaining color data other than the first color data by using a driving voltage for the first color data.

For example, when a display driver IC for driving the display panel 560b, having a same structure as shown in FIG. 7, operates in a gray mode, if power is not equal to or less than a first level (in a case of NO in operation S2620), that is, if power is not relatively low, the gray mode may be performed with reference to color data R. Accordingly, pixels for displaying color data B or G may be driven by using a driving voltage for the color data R in a gray mode. On the contrary, if power is equal to or less than the first level (in a case of YES in operation S2620), that is, if a problem with power may exist even when the display driver IC operates in a gray mode, the gray mode may be performed with reference to the color data G that may reduce power consumption while a display panel is being driven.

For example, a case when power is equal to or less than a first level may correspond to a case when a remaining capacity of a battery is equal to or less than 10% of a battery capacity. The method 2600 of controlling a display driver IC may be performed by setting a plurality of power levels instead of one level, so that the display driver IC may operate in a gray mode that is optimized for each power level. The controlling of the display driver IC may be performed by a host or independently by a control unit included in the display driver IC. This also applies to a method of controlling a display driver IC in a gray mode, according to another example embodiment.

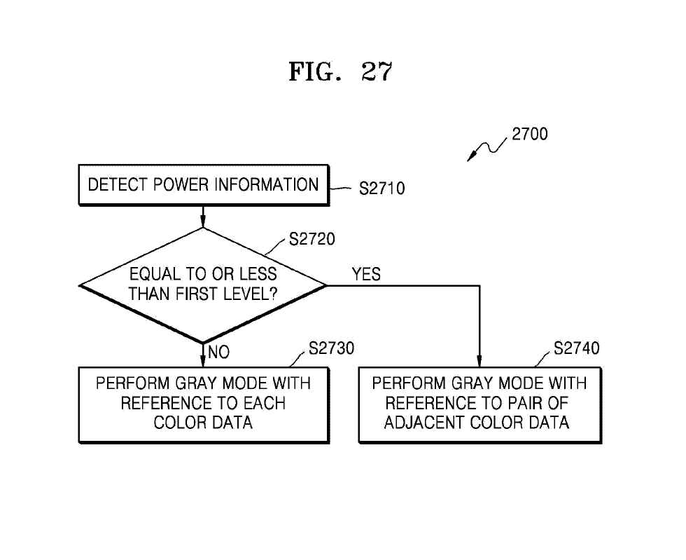

FIG. 27 illustrates a method 2700 of controlling a display driver IC in a gray mode, according to another example embodiment. The method 2700 of controlling a display driver IC includes detecting power information in operation S2710, checking if power of an electronic device that includes the display driver IC is equal to or less than a first level based on the power information in operation S2720, performing a gray mode with reference to each input data in operation S2730, which is performed by the display driver IC if the power of the electronic device is not equal to or less than the first level (in a case of NO in operation S2720), and performing the gray mode with reference to a pair of input data in operation S2740, which is performed by the display driver IC if the power of the electronic device is equal to or less than the first level (in a case of YES in operation S2720).

The performing of the gray mode with reference to each input data means that, by using a driving voltage processed for one piece of color data of each input data, remaining pieces of the color data of the input data other than the piece of the color data are displayed. A description of an example of performing a gray mode with reference to each input data is provided, but performing of a gray mode is not limited thereto. According to an example embodiment, if a problem with power exists in a display driver IC even when the display driver IC is operating in a gray mode, a driving voltage processed with respect to a piece of color data of a piece of input data, from among a pair of the input data to be displayed by an adjacent pixel, may be used to display remaining pieces of the color data, other than the piece of the color data of the pieces of the pair of the input data. Thus, power consumption may be reduced. Additionally, a driving voltage processed with respect to one piece of color data of one piece of input data, from among three or more pieces of the input data instead of a pair of the input data, may be used to display remaining pieces of the color data other than the piece of the color data.

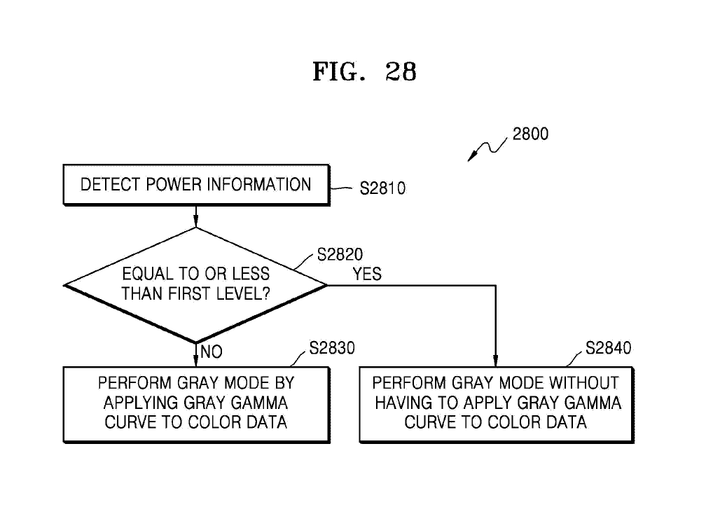

FIG. 28 illustrates a method 2800 of controlling a display IC in a gray mode according to another example embodiment. The method 2800 of controlling a display driver IC includes detecting power information in operation S2810, checking if power of an electronic device that includes the display driver IC is equal to or less than a first level based on the power information in operation S2820, performing a gray mode by applying gray-gamma correction to color data in operation S2830 if the power of the electronic device is not equal to or less than a first level (in a case of NO in operation S2820), and performing the gray mode in operation S2840 instead of performing the gray-gamma correction if the power of the electronic device is equal to or less than the first level (in a case of YES in operation S2820). As described with reference to FIG. 18, the performing of the gray mode by applying the gray-gamma correction to color data in operation S2830 may include performing gamma correction using a different color, such as red gamma correction, green gamma correction, or blue gamma correction, instead of the gray gamma correction. According to an example embodiment, if a problem with power exists in a display driver IC even when the display driver IC operates in a gray mode, driving power may be generated by performing only amplifying on color data, such as R, G, and B data, which is transmitted to a source driver, instead of performing the gamma correction thereon, and thus, power consumption may be reduced.

As such, according to an example embodiment, controlling of a display driver IC may be optimized according to a power state. Additionally, according to an example embodiment, a gray mode of a display driver IC may be set variously according to a type of application data. For example, when a display driver IC is operated in a gray mode, a different parameter may be used for photograph data from a parameter for text messages.

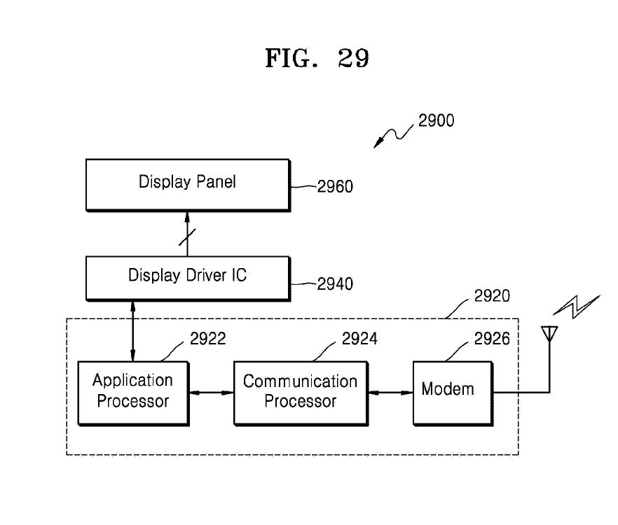

FIG. 29 illustrates an electronic device 2900 according to another example embodiment. Referring to FIG. 29, the electronic device 2900 may include a first module 2920, a display driver IC 2940, and a display panel 2960. The first module 2920 may include an application processor 2922, a communication processor 2924, and a modem 2926.

The application processor 2922 may process data received from the communication processor 2924, information about the received data, or data input via a user interface. The user interface may be provided to the display panel 2960 via the display driver IC 2940. A result of the processing performed by the application processor 2922 may be transmitted to the communication processor 2924 or the user interface. The communication processor 2924 may provide data received from outside via the modem 2926 or information regarding the received data to the application processor 2922, or output a result of processing performed by the application processor 2922 to outside. The communication processor 2924 may also display an image related to a phone call or a message on the display panel 2960 via the display driver IC 2940.

The display driver IC 2940 may be a display driver IC as shown in FIG. 1. Accordingly, according to an example embodiment, if a remaining capacity of a battery included in the electronic device 2900 becomes equal to or less than a reference value, the electronic device may operate in a gray mode, and thus, reduce power consumption.

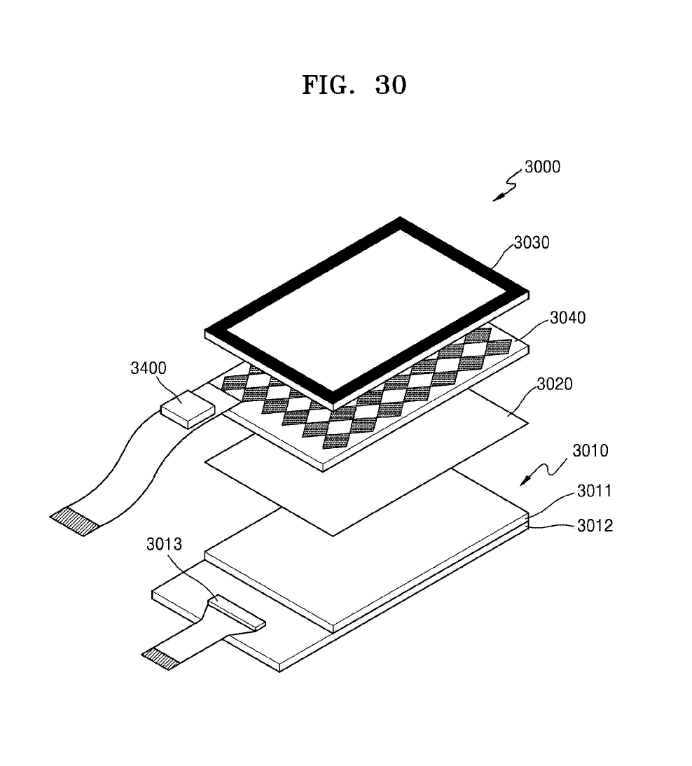

FIG. 30 illustrates a display module 3000 according to an example embodiment. Referring to FIG. 30, the display module 3000 includes a display device 3010, a polarizing plate 3020, and window glass 3030. The display device 3010 includes a display panel 3011, a printed circuit board (PCB) 3012, and a display driver IC 3013.

The window glass 3030 is generally formed of a material such as acryl or tempered glass, thus protecting the display module 3000 from external shock or scratches that may be caused by repeated touches. The polarizing plate 3020 may be included to enhance optical characteristics of the display panel 3011. The display panel 3011 is formed by patterning a transparent electrode on the PCB 3012. The display panel 3011 includes a plurality of pixel cells for displaying a frame. According to an example embodiment, the display panel 3011 may be an OLED panel. Each pixel cell includes an OLED for emitting light in correspondence with a flow of electricity. However, the display panel 3011 is not limited thereto, and examples of the display panel 3011 may include various types of display devices. For example, the display panel 3011 may be one selected from among an LCD, an ECD, a DMD, and an AMD, a GLV, a PDP, an ELD, an LED display, a VFD, etc.

The display driver IC 3013 may include a display driver IC as shown in FIG. 1. Accordingly, the display module 3000 may reduce power required for performing a display operation. It is shown that the display driver IC 3013 includes one chip. However, the display driver IC 3013 is not limited thereto, and may include a plurality of driving chips. Additionally, the display driver IC 3013 may be mounted on the PCB 3012 formed of glass in the form of chip-on glass (COG). However, this is only an example embodiment, and a display driver IC 3013 may be mounted in various forms such as a chip-on film (COF) or a chip-on board (COB).

The display module 3000 may further include a touch panel 3040 and a touch controller 3400. The touch panel 3040 is formed by patterning a transparent electrode such as indium tin oxide (ITO) on a glass board or a polyethylene terephthalate (PET) film. The touch controller 3050 detects a touch on the touch panel 3040, calculates a coordinate of the touch, and then, transmits the coordinate of the touch to a host (not illustrated). The touch controller 3050 may be integrated into the display driver IC 3013 and a semiconductor chip.

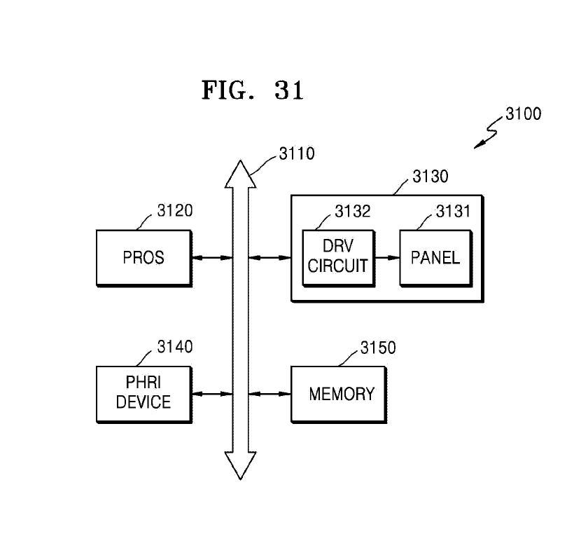

FIG. 31 illustrates a display system 3100 according to an example embodiment. Referring to FIG. 31, the display system 3100 may include a processor 3120 that is electrically connected to a system bus 3110, a display device 3130, a peripheral device 3140, and a memory 3150.

The processor 3120 may control data input/output to/from the peripheral device 3140, the memory 3150, and the display device 3130 and perform image processing on image data transmitted there between. The display device 3130 includes a panel 3131 and a driver IC 3132, and stores image data, applied via the system bus 3110, in the driving IC 3132 and displays the image data on the panel 3131. The driver IC 3132 may be a display driver IC as shown in FIG. 1. Accordingly, the display system 3100 may reduce power required for performing a display operation,

The peripheral device 3140 may be a device for converting a moving picture or a still picture into an electrical signal, such as a camera, a scanner, a webcam, etc. Image data obtained by using the peripheral device 3140 may be stored in the memory 3150, or displayed on a panel of the display device 3130 in real time. The memory 3150 may include a volatile memory device such as dynamic random access memory (DRAM) and/or a non-volatile memory device such as a flash memory. The memory 3150 may be formed of DRAM, parameter random access memory (PRAM), magnetic random access memory (MRAM), resistive random access memory (ReRAM), ferroelectric random access memory (FRAM), not-or (NOR) flash memory, and a fusion flash memory such as a memory into which a static random access memory (SRAM) buffer, a not-and (NAND) flash memory, and a NOR interface logic are combined. The memory 3150 may store image data obtained from the peripheral device 3140 or store an image signal processed by the processor 3120.

According to an example embodiment, the display system 300 may be included in a mobile electronic product such as a smartphone, but is not limited thereto. The display system 3000 may be included in various types of electronic products for displaying an image.

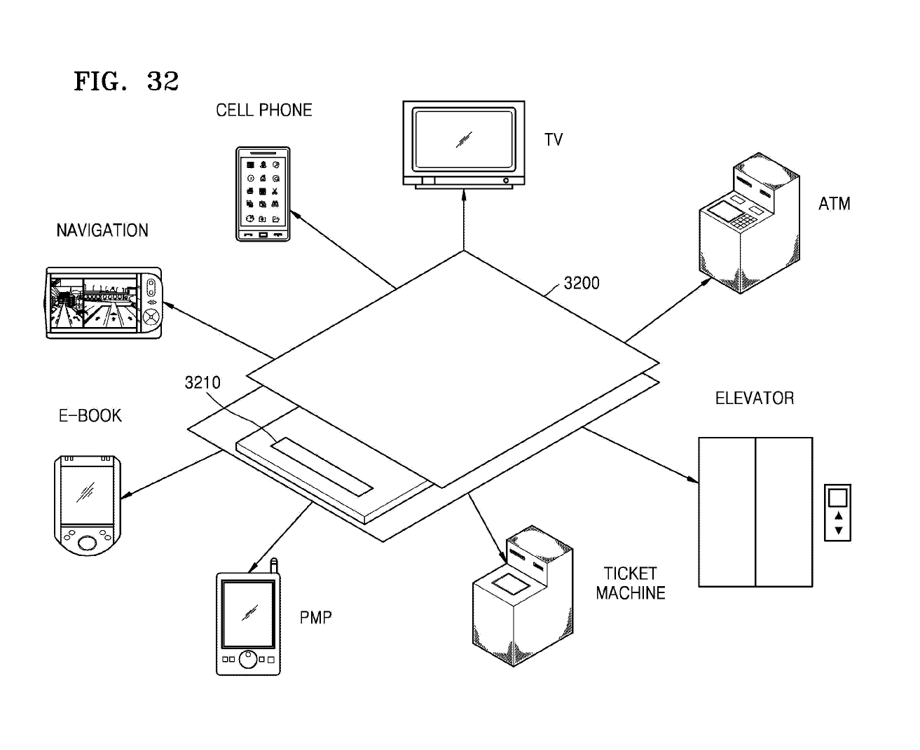

FIG. 32 illustrates an example embodiment of an application of various electronic devices in which a display driver IC 3200 is equipped, according to an example embodiment. According to an example embodiment, a display device 3200 that includes the display driver IC 3210 may be widely employed in, for example, a TV, an automatic teller machine (ATM) for automatically performing cash deposits or withdrawals instead of at a bank, an elevator, a ticket dispensing machine used in a subway station, a PMP, an e-book, a navigation system, etc., as well as a cellular phone. According to an example embodiment, the display driver IC 3210 may be a display driver IC as shown in FIG. 1. Accordingly, various electronic devices in which a display driver IC is equipped may reduce power the required for displaying an image.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A display driver integrated circuit (IC) comprising:
a controller configured to activate a gray mode signal based on an external signal that is input to the control unit; and
a data processor configured to operate in a gray mode, in response to the gray mode signal, the gray mode including processing input data as gray data.

2. (canceled)

3. The display driver IC of claim 1, wherein
the input data includes at least two types of color data; and
the data processor is further configured to process the input signal as the external signal and transmits the processed input signal to the display driver IC when the input data does not include at least one piece of color data associated with the at least two types of color data.

4. The display driver IC of claim 1, wherein the external signal comprises information regarding the power status of an electronic device that comprises the display driver IC.

5. The display driver IC of claim 1, further comprises:
at least two data paths, each data path including at least one sub-path; and
the data processor is further configured to,
deactivate at least one sub-path included in at least one data path selected from the group including at least two data paths, and
process the input data as a driving voltage to drive a display panel in a normal mode, the input data including at least two pieces of color data.

6. The display driver IC of claim 5, wherein at least one non-deactivated sub-path comprises circuitry configured to perform compression or decompression on the at least two pieces of color data.

7. The display driver IC of claim 5, wherein at least one non-deactivated sub-path comprises a circuitry configured to perform image processing on the at least two pieces of color data.

8. The display driver IC of claim 5, wherein at least one non-deactivated sub-path comprises a source driver configured to generate a driving voltage in accordance to the at least two pieces of color data.

9. (canceled)

10. The display driver IC of claim 5, wherein at least one non-deactivated sub-path comprises a circuitry configured to perform gamma correction on the at least two pieces of color data.

11-12. (canceled)

13. The display driver IC of claim 1, wherein the data processing unit comprises:
an encoder configured to compress the input data;
a graphics memory configured to store the compressed input data;
a decoder configured to decompress the stored compressed data;
an image processor configured to perform image processing on the decompressed data; and
a source driver configured to process the image-processed data as a driving voltage for driving a display panel.

14. The display driver IC of claim 13, wherein the data processor further comprises a data distribution unit configured to distribute, to the encoder in response to the gray mode signal, one piece of color data selected from a group including at least two pieces of color data from the input data.

15. (canceled)

16. The display driver IC of claim 13, wherein the source driver comprises:
a gamma correction unit configured to generate the image-processed data as a gamma-corrected analog voltage; and
an amplifying unit configured to amplify and output the gamma-corrected analog voltage as the driving voltage,
wherein the gamma correction unit is configured to receive one piece of color data selected from a group including at least two pieces of color data from the input data, in the gray mode.

17-19. (canceled)

20. The display driver IC of claim 1, wherein
the data processing unit is configured to generate the gray data as a driving voltage for all color data comprised in the input data, the generation based on processing of a driving voltage for a first color data selected from a group including at least two pieces of color data from the input data, if power of an electronic device that comprises the display driver IC is in a first state; and
the data processing unit is configured to generate the gray data as a driving voltage for all color data comprised in the input data, the generation based on processing a driving voltage for second color data selected from the group including at least two pieces of color data comprised in the input data, if power of the electronic device that comprises the display driver IC is in a second state.

21. The display driver IC of claim 1, wherein
the data processor is configured to generate the gray data by processing a driving voltage for a first color data selected from the group including at least two pieces of color data from each input data, as a driving voltage for all color data comprised in the input data, if power of an electronic device that comprises the display driver IC is in a first state, and
the data processor is configured to generate the gray data by processing a driving voltage for the first color data selected from the group including at least two pieces of color data comprised in one piece of the input data selected from the group including at least two pieces of the input data, as a driving voltage for all color data comprised in the at least two pieces of the input data, if power of the electronic device that comprises the display driver IC is in a second state.

22. The display driver IC of claim 1, wherein the data processor is configured to operate in a normal mode in which a driving voltage is generated for at least two pieces of color data from the input data, if the gray mode signal is deactivated.

23-24. (canceled)

25. An electronic device comprising:
a display driver integrated circuit (IC);
a display panel configured to be driven by using a driving voltage applied from the display driver IC; and
the display driver IC comprises:
a controller configured to activate a gray mode signal based on an external signal; and
a data processor configured to generate the driving voltage in response to the gray mode signal, so that input data is displayed as gray data on the display panel.

26. An electronic device comprising:
a display panel configured to display an image in accordance with driving voltages;
a display driver integrated circuit (IC) configured to drive the display panel according to an input data, the display driver IC including,
a controller configured to receive image data, the image data including a plurality of color data types; and
the data processor configured to process the image data according to a received gray mode signal, the gray mode signal indicating whether the data processor operates in a gray mode or a normal color mode, the processing including generating the driving voltages for the display panel based on the image data and the gray mode signal.

27. The device of claim 26, wherein if the data processor is operating under the gray mode, the data processor is configured to generate the driving voltages based on the image data without including color information.

28. The device of claim 26, further comprising:
a power management integrated circuit (PMIC) configured to detect power information associated with the electronic device and generate the gray mode signal based on the detected power information.

29. The device of claim 28, wherein the PMIC is further configured to generate the gray mode signal indicating that the data processor is to operate in the gray mode, if the detected power information is equal to or below a desired level.

30. The device of claim 26, wherein the received gray mode signal is the received image data.
